(19) United States
(12) Patent Application Publication
(10) Pub. No.: US 2020/0163356 A1
(43) Pub. Date: May 28, 2020

(54) HYDROGENATED VEGETABLE OIL WITHOUT ANY TRANS FATTY ACIDS

(71) Applicant: Purdue Research Foundation, West Lafayette, IN (US)

(72) Inventors: KEVIN MICHAEL KEENER, AMES, IA (US); Ximena YEPEZ, West Lafayette, IN (US)

(73) Assignee: Purdue Research Foundation, West Lafayette, IN (US)

(21) Appl. No.: 16/699,463

(22) Filed: Nov. 29, 2019

Related U.S. Application Data
(60) Provisional application No. 62/772,283, filed on Nov. 28, 2018.

(51) Int. Cl. A23D 9/04; C11C 3/12

(52) U.S. Cl. CPC A23D 9/04; C11C 3/12

(57) ABSTRACT

This present invention generally relates to a process for manufacturing hydrogenated vegetable oil without any significant amount of trans fatty acids for food and feed industry using high voltage atmospheric cold plasma (HVACP) in the presence of a working gas, and in particular to a process for manufacturing hydrogenated vegetable oil that meet the FDA's criteria of GRAS (generally considered as safe). A product of this process is also within the scope of this disclosure.

### CROSS-REFERENCE TO RELATED APPLICATIONS

The present U.S. patent application is related to and claims the priority benefit of U.S. Provisional Patent Application Ser. No. 62/772,283, filed Nov. 28, 2018, the contents of which are hereby incorporated by reference in their entirety into the present disclosure.

### TECHNICAL FIELD

This present invention generally relates to a process for manufacturing hydrogenated vegetable oil without any significant amount of trans fatty acids for food and feed industry using high voltage atmospheric cold plasma (HVACP) in the presence of a working gas,

### BACKGROUND

This section introduces aspects that may help facilitate a better understanding of the disclosure. Accordingly, these statements are to be read in this light and are not to be understood as admissions about what is or is not prior art.

Atmospheric cold plasma (ACP) technology has been getting more importance as a non-thermal processing technique to inactivate pathogenic microbes in food products (Surowsky, et al., Int'l J. Food Microbiol. 174 (2014) 63-71). The technique utilizes an electrical discharge between two electrodes which lead to generation of cold plasma, a source of electrons, ions, UV light, and reactive gas species, which assist inactivating pathogenic microbes and therefore offer a useful sterilization process. Atmospheric cold plasma has been applied to a wide range of food products, including cheese, lettuce, egg shells, blue berries, strawberries, ham, pork loins, and bacon (ibid.), and liquid products, such as milk, juices (Almeida, et al., Innovative Food Science and Emerging Technologies, 32 (2015), 127-135; Kim, et al., Food Control 47(2015) 451-456).

Lipid Chemistry.

Lipids are known as non-polar molecules, because they lack of partial positive or negative charges, and they are not capable of forming hydrogen bonds with other molecules. Lipids include fatty acids, glycerides, waxes, sterols, fat soluble vitamins, sphingo-lipids, carotenoids, and glycolipids. In particular, triglycerides are the most abundant lipids, and they are formed by three fatty acids joined together with a glycerol molecule through ester bonds. Triglycerides are the main component of fats and oils, and are used widely as food ingredients from animal and vegetable sources. Liquid oils and solid fats are used for baking, frying, salad dressings, cooking, and confectionery products. They play an important role by providing flavor, texture, satiety, lubricity, and cohesiveness to food.

Vegetable oils such as soybean, sunflower, and corn oil are liquid because they have a high content of unsaturated fatty acids. In contrast, solid vegetable fats such as palm and coconut oil are produced mainly in the tropics, and they are semisolid at room temperature, due to its high content of saturated fatty acids. Solid fats are valued as a food ingredients because they provide texture, high oxidation stability, and high melting point.

Fatty Acids and Triglycerides.

Fatty acids are hydrocarbon chains with a terminating carboxylic group in one side, and a methyl group in the other side. Fatty acids found in nature are formed mostly by 6-22 carbons. The hydrocarbon chain may include single or double covalent bonds. Single bonds allow rotation of hydrogen atoms along the axis, and have a σ bond. Double bonds give a planar configuration of carbon-carbon bond, because it does not allow rotation of the hydrogen atoms, and the double bonds have a σ and π bonds.

Saturated fatty acid means that all carbons are filled with hydrogen and joined by simple bonds, forming a linear chain. They are characterized as solid at room temperature. Unsaturated fatty acids include simple and double bonds between carbon-carbon. Unsaturated fatty acids are liquid at room temperature because double bonds bend the hydrocarbon chain, and do not stack together.

Double bonds can have a cis- or trans-geometric configuration, according to the position of the hydrogen linked to the carbon-carbon double bond. A cis-configuration is characterized by hydrogen atoms in the same side of the molecule, therefore cis-configuration bend the hydrocarbon chain at the double bond location. In contrast, trans-geometric configuration is formed by hydrogen at alternative location of the double bond, therefore a trans-configuration have a linear chain that behave as a saturated fatty acid, and they can be solid at room temperature, even if they have one or two double bonds. Trans-isomers are mainly produced by catalytic hydrogenation, however some trans fatty acids are found naturally in dairy products at low concentrations.

The major vegetable oil produced in the U.S. is soybean oil, with a production of 22.6 million pounds per year, which is equivalent to 64.9% of the total vegetable oil. Followed by corn and canola oil with a production of 6.1 and 1.7 million pounds per year. Crude soybean oil is formed by 95-97% of triglycerides, 2.5-3% of phospholipids, and minor components that include unsaponificable matter (phytosterols, tocopherols), free fatty acids, or trace metals. These impurities are removed to meet quality and stability standards of a refined product. The composition of refined soy-bean oil is >99% of triglycerides [1]. Triglycerides of soybean oil are formed mainly by the following fatty acids: palmitic, stearic, oleic, linoleic, and linolenic acid.

### Hydrogenation

Paul Sabatier was honored with the Nobel Prize in chemistry for the invention of the method of catalytic hydrogenation. The reaction consisted in treating a substrate with hydrogen gas, a catalyst, and high temperatures. Initially, this reaction was tested in different compounds such as benzene, aldehydes or nitriles, previous the application in fats and oils. Wilhelm Norman applied the principle of this reaction to liquid oils, and it was until 1909 that the first large scale plant was constructed as a food processing facility.

A liquid oil is transformed into a solid fat by the catalytic hydrogenation, where hydrogen atoms binds into double bonds of unsaturated fatty acids, in consequence the double bond change into a simple bond. This reaction requires the use of a catalyst, agitation, high temperature and pressure. This reaction is exothermic, releases approx. 1 kcal/kg per each unit of iodine value reduction. A full hydrogenation can be achieved if hydrogen is available to react with the double bonds, however the reaction rate become slower when there is less quantity of unsaturated fatty acids. Overall, a vegetable oil with less amount of unsaturated fatty acids is more resistant to oxidation, and provide an extended shelf life to food products.

Iodine value is one of the main indicators of the hydrogenation reaction, since it represents a measurement of the amount of double bonds. For example, a traditional process of partial hydrogenation of soybean oil reduce iodine value from 130 to 80 (g of iodine/100 g of oil), in a process of 1-2 h. Although, depending if the final product require to have different properties, the iodine value can be in the range of 100-110 for a soft, 80-85 for a flat, 60-75 for a steep, or less than 10 for a hard product [2].

A hydrogenated oil have a higher oxidation stability and increased melting point. First, the reduced number of double bonds turn this product less susceptible to get oxidized by the presence of light, metal or other agents that initiate oxidation reactions. Therefore hydrogenation increase the shelf life of vegetable oils. Second, when a double bond is hydrogenated, the hydrocarbon chain become linear and can stock together with other saturated fatty acids because of non-covalent interactions. As a consequence the melting point increases, and the partially hydrogenated vegetable oil turns solid at room temperature.

These properties make the PHO's a suitable ingredient for baking, frying, and confectionery (PHO: partially hydrogenated oil). For example, cocoa butter has a melting point close to the human temperature, and provide a mouth-feel sense of smoothness and softness, which is difficult to replace with any other low cost source vegetable oil. Partially hydrogenated oil (PHO) behaves like cocoa butter and it is used as a low cost alternative for cocoa products maintaining its properties. A high melting point PHO is used for frying applications, as this product provides a dry appearance because it turns semi-solid at room temperature. In addition, PHO stability provide an extended shelf life to food products.

### Trans Fatty Acids and Health

The traditional hydrogenation process yields approximately 25-40% of trans fatty acids [6]. Trans fatty acids are found naturally in low quantities in fats from dairy and meat products (2-5%), but the largest source comes from PHOs [8]. The consumption of trans fatty acids have been linked to a significant risk factor for cardiovascular diseases, raising the bad low-density lipoprotein cholesterol and reducing the good high-density lipoprotein cholesterol levels, as well as inflammatory effects and endothelial dysfunction [9]. FDA estimated that 1200 coronary events and 480 deaths from heart diseases can be prevented each year by reducing the consumption of trans-fat from 0.60% to 0.04% of total energy intake [10].

In 2003, the Food and Drug Administration (FDA) in the U.S. issued the trans-fat labeling requirement for food products. Since then, food companies initiate to replace PHOs from their product formulations. In January 2006, food companies were required to declare the amount of trans fat in food on the nutritional fact label. At that time the label can state 0% trans if the content of total trans fatty acid were less than 0.5 g per serving, and many companies reformulated their foods or reduce the serving size in order to label as zero trans fats. In June 2015, the FDA made a final determination that PHOs were not recognized as safe for any use in human food. FDA gave a compliance date until June 2018 to remove this ingredient from the marketplace. At the time, the replacement of PHOs were mainly with tropical oils such as palm and coconut oils, inter-esterified oils, fully hydrogenated oil, and genetically modified vegetable oils [11]. In Europe, PHOs are still allowed to use as ingredients, but there is currently a proposal to limit the use to a maximum of 2 g in 100 g of fat.

There are unmet needs for a process to prepare hydrogenated vegetable oils with low or without any trans fatty acids for food, feed, and other industries.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the interest of clarity, not all the routine features of the examples herein are described. It will of course be appreciated that in the development of any such actual implementation, numerous implementation-specific decisions must be made to achieve a developer's specific goals, such as consideration of system, regulatory, and business related constraints. These goals will vary from one implementation to another.

In the present disclosure the term “about” can allow for a degree of variability in a value or range, for example, within 10%, within 5%, or within 1% of a stated value or of a stated limit of a range.

In the present disclosure the term “substantially” can allow for a degree of variability in a value or range, for example, within 80%, within 90%, within 95%, or within 99% of a stated value or of a stated limit of a range.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

All current described herein is alternating current, specified as volts (V) and kilovolts (kV) root mean squared (RMS). Percent (%) gas compositions are in volume percentages.

A cold plasma refers to plasma which has a temperature of at most 40° C. above the temperature of the gas used to prepare the plasma (that is, the working gas), more preferably a temperature of at most 20° C. above the temperature of the gas used to prepare the plasma.

High-voltage cold plasma (HVCP) means a cold plasma prepared using a dielectric barrier discharge (DBD) system, using voltages of at most 500 kV, with a frequency at most to 1000 Hz, prepared from a gas having a pressure of 10 to 50000 Torr, such as 760 Torr (atmospheric pressure). HVCP is not a thermal plasma, is not a microwave plasma and is not a radio frequency (RF) plasma. HVCP plasmas are prepared under non-equilibrium breakdown conditions.

Dielectric barrier discharge (DBD), or a DBD system, means a system having at least two electrodes separated by a dielectric barrier, and may have more electrodes, where a dielectric barrier is present between each electrode, to prevent charge generated in the gas by a discharge from reaching an electrode. The shortest distance between adjacent electrodes in a DBD system is preferably at most 30 cm (or 12 inches), and preferably is at least 0.5 cm (˜0.25 inches). Preferably, DBD systems are configures to operate under conditions to produce an HVCP.

High Voltage Atmospheric Cold Plasma (HVACP):

Plasma is defined as the fourth state of matter. Atmospheric cold plasma (ACP) is a natural phenomenon that has been converted into a valuable technology. The Northern Lights (aurora borealis) is a cold plasma resulting from charged particles emitted from the sun interacting with the earth's magnetic field and causing ionization.

Industrial applications of atmospheric cold plasma have been in use for over 150 years. The first atmospheric, cold plasma was invented by Werner von Siemens in 1857 (W. Siemens, Poggendorff's Ann. Phys. Chem. 102, 66 (1857)). This system was a dielectric barrier discharge system where air was passed between two parallel plates, with a voltage differential to generate ozone and used for water treatment (U. Kogelschatz, Plasma Chemistry and Plasma Processing, Vol. 23, No. 1, 1-46 (2003)). Plasmas can be generated in any gas environments (examples are air, O₂, H₂, N₂, and CO₂) with either direct current (DC) or alternating current (AC).

ACP has found applications for use in areas including surface cleaning, surface property alteration, air cleaning, automobile exhaust gas cleaning, UV generation, ozone production, etc. ACP capitalizes on the chemical properties of gases and the physics of electric fields. When voltage gradients of adequate strength are experienced by a gas; a few gas molecules can be stripped of a free electron (ionization). These electrons then proceed to be reactive with the bulk gas generating light, UV, and unique reactive gas species (ozone, nitric oxides, peroxides, atomic oxygen, etc.) many of which have bactericidal properties. There are many different types of ACP systems, and these are characterized by the plasma formation. Examples of ACP's would include plasma jet, microwave plasma, dielectric barrier discharge (DBD), and corona discharge.

Atmospheric pressure “cold” plasmas have been shown to be effective in reducing or eliminating surface bacterial contamination of food samples. The term “cold plasma” is meant to describe a plasma discharge, which may be atmospheric non-equilibrium plasma (ANEP), occurring at a pressure of about one-atmosphere and at near ambient temperature. This is to distinguish the ANEP plasma from a thermal plasma discharge operating at a bulk gas temperature of hundreds or thousands of degrees above the ambient temperature. In a “cold plasma” at atmospheric pressure the electrons may have a significantly higher temperature than the ion and neutral species; however, the bulk temperature of the working gas is not significantly increased with respect to the ambient temperature In this context, the term “cold” should not be interpreted to require refrigeration or other cooling to perform the decontamination or treatment functions described herein; however, this does not exclude the treating or the subsequent storage of the treated object at an appropriate temperature, which may include refrigeration or cooling. Keeping the gas at a near ambient temperature may contribute to avoidance of heat damage to the object being treated.

One technique of creating an atmospheric non-equilibrium plasma is to apply a high voltage to the volume to be ionized, while inhibiting the transition from a glow discharge to an arc discharge by limiting the discharge current. This may be done, for example, by covering at least one of the electrodes of the apparatus with a dielectric layer; resistive layers have also been used. The discharge current is self-limited by charge build up on the dielectric surface. Typically, the excitation voltage frequency is in the kHz range, but may range from power line frequencies to microwave frequencies. The experimental data presented herein used a 60 Hz frequency due to the availability of high voltage transformers, whose output voltage could be easily be adjusted by controlling the input voltage thereof with a variable voltage transformer. The voltage for this cold plasma generation purpose normally ranges from about 5,000 volts (5 kV) to about 500 kV, preferably from about 30 kV to about 120 kV, having a frequency of at most 1000 Hz, more preferably 10 to 100 Hz, such as 50 to 60 Hz, with a DBD system.

Dielectric-barrier discharges (DBD) are a type of alternating-current high voltage gaseous discharges that may be formed in a nominally atmospheric pressure environment. The presence of a dielectric layer between the electrodes prevents the charge generated in the gas by the discharge from reaching at least one of the conducting electrode surfaces. Often the dielectric layer is applied to both of the electrodes. Within each half-cycle of the driving voltage waveform, when the voltage gradient applied across the gas exceeds that required for breakdown, the formation of narrow ionized discharge filaments initiates the conduction of electrons toward the more positive electrode, and ions towards the more negative electrode, although the mobility of the electrons is greater than that of the ions. An electrical charge accumulates on the dielectric layer(s) at the end(s) of each ionized filament; and, the voltage drop across the ionized filament reduces until the voltage falls below the discharge-sustaining level, so that the discharge is extinguished. The duration of the filamentary discharge is believed to be quite short: of the order of 100 nanoseconds or less. However, the resultant reactive species may have a significantly longer lifetime. The low charge mobility along the surface of the dielectric also limits the lateral region over which the gap voltage is diminished, so that a plurality of filaments may form in close proximity to one another.

A liquid object to be treated is placed substantially closed to and between the two dielectric barriers connected to a high voltage generating system in a defined compartment. The compartment is filled with air, a single or mixed gases, including, but not limited to O₂, N₂, CO₂, H₂O, Cl₂, as well as noble gases. The defined compartment should have an ability to substantially retain the reactive species that are the residual of the generated ANEP plasma for a period of time that is sufficient for a particular treatment process. The working gas, which may be air, or a modified mixture M65 (composition 65% O₂, 30% CO₂, 5% N₂), may be introduced into the compartment prior to treatment.

Working gas here means a gas either pure or in combination with other gases which can be used to generate plasma when an electrical field is applied to it. Different selection of working gases and working gas mixtures will affect the species present in the reactive gas produced by the HVCP. Further examples of gases which may be used to prepare the HVCP include oxygen (O₂); nitrogen (N₂); water vapor (H₂O); inert and noble gases such as helium (He), neon (Ne), argon (Ar), krypton (Kr), xenon (Xe) and sulfur hexafluoride (SF₆); hydrogen (H₂); carbon dioxide (CO₂) and carbon monoxide (CO); halogens and pseudohalogens such as fluorine (F₂), chlorine (Cl₂), bromine (Br₂), and cyanogen ((CN)₂); acidic gases such as hydrogen sulfide (H₂S), hydrogen fluoride (HF), hydrogen chloride (HCl), and carbonyl sulfide (COS); ammonia (NH₃); hydrazine (N₂H₄); nitrogen trifluoride (NF₃); chlorine dioxide (ClO₂); hydrocarbons such as methane (CH₄), ethane (C₂H₆) and acetylene (C₂H₂); alcohols such as methanol (CH₃OH) and ethanol (C₂H₅OH); and mixtures thereof. Preferred gases include air and MA65 (a mixture of 65% O₂, 30% CO₂, and 5% N₂). Increasing the amount of water vapor in the gas may be used to reduce ozone present in the reactive gas. Increasing the amount of noble gas, such as helium, may be used to reduce the voltage needed to produce the HVCP. The pressure of the gas use to prepare the HVCP is conveniently selected as ambient or atmospheric pressure, but other pressures may be used, such as 10 to 50000 Torr, more preferably 100 to 1000 Torr, such as 760 Torr (atmospheric pressure).

Oxidation.

Oxidation change the physical properties of food, by the formation of volatiles or other reaction products that change the quality of food products. Animal fats such as butter, lard or edible tallow, and tropical vegetable oils are rich in saturated fatty acids. They have a high melting point and maintains a solid or semisolid state at room temperature. Fats rich in saturated fatty acids are less susceptible to oxidation, therefore the addition of fats rich in saturated fatty acids to food products allow to extend their shelf life. In contrast, liquid vegetable oils are susceptible to oxidation, specially if they are exposed to light, metals, oxygen, or any other condition that accelerate the oxidation reaction. Linolenic acid (C18:3) get oxidized 2.4 times faster than linoleic acid (C18:2), and the latter 40 times faster than oleic acid (C18:1) [12, 13]. Lipid oxidation is one of the major causes of food quality deterioration, by development of off flavors, color degradation, and destroying essential fatty acids.

Oxygen react with unsaturated fatty acids by different pathways according to its energetic state. The oxygen molecule can exist in two energetic forms known as triplet and singlet. Singlet state (22.4 kcal/mol) is more reactive than the triplet state, and they are formed by the effect of enzymes, light, or chemicals reactions. Triplet oxygen is associated with autoxidation reactions, while singlet oxygen is related with photo-oxidation reactions of olefinic compounds.

The mechanism of lipid autoxidation reaction has 3 stages: initiation, propagation, and termination [14]. The reaction starts when a hydrogen is subtracted from the allylic carbon forming a fatty acid radical (initiation), by the presence of heat, metal catalyst, ultraviolet or visible light. Afterwards, the fatty acid radical re-arranges forming a conjugated dienes, then oxygen is absorbed to form peroxyl radicals (propagation). Then, a serial chain of reactions occurs at this point, with the formation of peroxides, cleavage of hydrocarbon chains, and formation of non-radical products (termination).

In some illustrative embodiments, the invention relates to a process for manufacturing a hydrogenated vegetable oil without any significant amount of trans fatty acids using a high voltage atmospheric cold plasma (HVACP), comprising the steps of:
a. preparing vegetable oil;
b. setting up a defined compartment filled with a working gas in the presence of water and an electric system for generating atmospheric cold plasma (ACP);
c. generating ACP by applying a high electric voltage through a controller; and
d. exposing said vegetable oil to said ACP in said defined compartment to afford said hydrogenated vegetable oil without any significant amount of trans fatty acids.

In some illustrative embodiments, the invention relates to a process for manufacturing a hydrogenated vegetable oil without any significant amount of trans fatty acids using a high voltage atmospheric cold plasma (HVACP), wherein said ACP is generated by applying an electric voltage from about 5,000 volts to about 200,000 volts between two dielectric barriers for a period of time.

In some illustrative embodiments, the invention relates to a process for manufacturing a hydrogenated vegetable oil without any significant amount of trans fatty acids using a high voltage atmospheric cold plasma (HVACP), wherein said ACP is generated by applying an electric voltage from about 30,000 volts to about 120,000 volts between two dielectric barriers for a period of time.

In some illustrative embodiments, the invention relates to a process for manufacturing a hydrogenated vegetable oil without any significant amount of trans fatty acids using a high voltage atmospheric cold plasma (HVACP), wherein said hydrogenated vegetable oil has an iodine value of 100 or lower.

In some illustrative embodiments, the invention relates to a process for manufacturing a hydrogenated vegetable oil without any significant amount of trans fatty acids using a high voltage atmospheric cold plasma (HVACP), wherein said working gas is a single or a mixture of combined gases.

In some illustrative embodiments, the invention relates to a process for manufacturing a hydrogenated vegetable oil without any significant amount of trans fatty acids using a high voltage atmospheric cold plasma (HVACP), wherein said working gas is air, hydrogen, nitrogen, oxygen, carbon dioxide, noble gases, water, or a combination thereof.

In some illustrative embodiments, the invention relates to a process for manufacturing a hydrogenated vegetable oil without any significant amount of trans fatty acids using a high voltage atmospheric cold plasma (HVACP), wherein said working gas is air.

In some illustrative embodiments, the invention relates to a process for manufacturing a hydrogenated vegetable oil without any significant amount of trans fatty acids using a high voltage atmospheric cold plasma (HVACP), wherein said working gas is a modified air comprising about 65% oxygen, about 30% carbon dioxide, and about 5% nitrogen.

In some illustrative embodiments, the invention relates to a process for manufacturing a hydrogenated vegetable oil without any significant amount of trans fatty acids using a high voltage atmospheric cold plasma (HVACP), wherein said vegetable oil is soybean oil, corn oil, canola oil, peanut oil, or a combination thereof.

In some illustrative embodiments, the invention relates to a process for manufacturing a hydrogenated vegetable oil without any significant amount of trans fatty acids using a high voltage atmospheric cold plasma (HVACP), wherein said vegetable oil is soybean oil.

In some illustrative embodiments, the invention relates to a process for manufacturing a hydrogenated vegetable oil without any significant amount of trans fatty acids using a high voltage atmospheric cold plasma (HVACP), wherein said vegetable oil is canola oil.

In some illustrative embodiments, the invention relates to a process for manufacturing a hydrogenated vegetable oil without any significant amount of trans fatty acids using a high voltage atmospheric cold plasma (HVACP), wherein said vegetable oil is peanut oil.

In some illustrative embodiments, the invention relates to a process for manufacturing a hydrogenated vegetable oil without any significant amount of trans fatty acids using a high voltage atmospheric cold plasma (HVACP), wherein said hydrogenated vegetable oil contains little or no trans fatty acids.

In some illustrative embodiments, the invention relates to a process for manufacturing a hydrogenated vegetable oil without any significant amount of trans fatty acids using a high voltage atmospheric cold plasma (HVACP), wherein said hydrogenated vegetable oil meets the criteria of the United States Food and Drug Administration for GRAS (generally regarded as safe).

In some other illustrative embodiments, the invention relates to a product of hydrogenated vegetable oil manufactured by using high voltage atmospheric cold plasma (HVACP), according a process comprising the steps of:
a. preparing vegetable oil;
b. setting up a defined compartment filled with a working gas in the presence of water and an electric system for generating atmospheric cold plasma (ACP);
c. generating ACP by applying a high electric voltage through a controller; and
d. exposing said vegetable oil to said ACP in said defined compartment to afford said hydrogenated vegetable oil without any significant amount of trans fatty acids.

In some other illustrative embodiments, the invention relates to a product of hydrogenated vegetable oil manufactured by using high voltage atmospheric cold plasma (HVACP), according a process disclosed herein, wherein said working gas is air, hydrogen, nitrogen, oxygen, carbon dioxide, noble gases, water, or a combination thereof.

In some other illustrative embodiments, the invention relates to a product of hydrogenated vegetable oil manufactured by using high voltage atmospheric cold plasma (HVACP), according a process disclosed herein, wherein said ACP is generated by applying an electric voltage from about 30,000 volts to about 120,000 volts between two dielectric barriers for a period of time.

In some other illustrative embodiments, the invention relates to a product of hydrogenated vegetable oil manufactured by using high voltage atmospheric cold plasma (HVACP), according a process disclosed herein, wherein said vegetable oil is soybean oil.

In some other illustrative embodiments, the invention relates to a product of hydrogenated vegetable oil manufactured by using high voltage atmospheric cold plasma (HVACP), according a process disclosed herein, wherein said corn oil.

In some other illustrative embodiments, the invention relates to a product of hydrogenated vegetable oil manufactured by using high voltage atmospheric cold plasma (HVACP), according a process disclosed herein, wherein said canola oil.

In some other illustrative embodiments, the invention relates to a product of hydrogenated vegetable oil manufactured by using high voltage atmospheric cold plasma (HVACP), according a process disclosed herein, wherein said peanut oil.

In some other illustrative embodiments, the invention relates to a product of hydrogenated vegetable oil manufactured by using high voltage atmospheric cold plasma (HVACP), according a process disclosed herein, wherein said soybean oil, corn oil, canola oil, peanut oil, or a combination thereof.

In some other illustrative embodiments, the invention relates to a product of hydrogenated vegetable oil manufactured by using high voltage atmospheric cold plasma (HVACP), according a process disclosed herein, wherein said hydrogenated vegetable oil contains little or no trans fatty acids.

In some other illustrative embodiments, the invention relates to a product of hydrogenated vegetable oil manufactured by using high voltage atmospheric cold plasma (HVACP), according a process disclosed herein, wherein said hydrogenated vegetable oil meets the criteria of the United States Food and Drug Administration for GRAS (generally regarded as safe).

Analytical Techniques for Lipid Analysis

Gas Chromatography.

In this study, gas chromatography was used to the identification of fatty acids and quantification (% by weight). This technique is used for fatty acid analysis because fatty acids with the same molecular weight can be separated according to the position of a double bond, and it also allows to determine the geometric isomers cis- and trans-

In order to analyze with GC, it is required to derivatize the triglycerides into fatty acid methyl esters (FAME), because FAME have a lower molecular weight and are polar. The derivatization is a transesterification reaction, where the glycerol of the triglyceride is displaced by an alcohol in the presence of an acid, to form fatty acid methyl esters and glycerol [25].

The mixture of fatty acid methyl esters is separated with a temperature gradient in a capillary column, because FAME's of vegetable oils differ from each other by their volatility and polarity. However, the elution time of each FAME depends of the nature of the column and experimental conditions. Optimal conditions allow to separate FAME by the carbon chain length, degree of unsaturation, geometrical isomers, and position of double bonds. A flame ionization detector (FID) is adequate for quantification of FAME, and it is the standard method for fatty acid composition.

FTIR.

FTIR is an important tool to analyze fatty acids and triglycerides structure, because polar molecules are associated with strong IR absorption. Infrared bands indicate molecular vibrations, such as bonds stretching or bending. The absorption intensities of this vibrations can be strong, medium or weak for different types of bonds.

Nuclear Magnetic Resonance.

Nuclear magnetic resonance utilizes a magnetic field to align the nucleus of specific atoms that possess magnetic moment (Ex. ¹H, ¹³C), and analyze their behavior by applying electromagnetic radiation that promote transitions in nuclear energy levels. As a result this technique determine the structure of molecules, as an example in 1H-NMR the protons of each part of the organic molecule absorb energy depending on the local chemical structure.

The process of identify the NMR spectrum start with a relaxation delay, that allow the nuclei to align. Then a short pulse is applied by a high-power radio frequency, afterwards a free induction decay is produced, and it is recorded during the acquisition time. The signal is then analyzed accordingly by a Fourier transformation, to obtain a plot of the intensity of absorption vs. frequency. This plot is usually expressed by ppm in the x-axis (chemical shift), which is directly proportional to the magnetic field strength. The whole process has a duration of few seconds, but the signal of one acquisition is not enough to have a good signal, therefore it is required to repeat this process to improve the signal-to-noise ratio. Functional groups of triglycerides and fatty acids corresponding to ¹H-NMR and ¹³C-NMR with numbers from 1-11. The corresponding numbers are described in detail in Table 1. Quality parameters such as fatty acid composition, free fatty acids, or fatty acid structure can be analyzed with ¹H-NMR [26, 27]. Oxidation products are characterized by the presence of hydroperoxides (chemical shift 5.72, 8.3-8.9), aldehydes (chemical shift 9.5-9.8, FIG. 3-c), alcohols (chemical shift 3.43-3.62), epoxides (chemical shift 2.63, 2.88-2.90, 3.1), or ketones (chemical shift 6.08, 6.82) [28, 29].

Cold plasma.

Plasma is the fourth state of matter, alongside with solid, liquid and gas. In a plasma state the molecules are not only distant from each other, but also they break apart into their atomic elements. Therefore, plasma is formed by a partially ionized gas, where excited species, ions, and electrons coexist in a charged electric field. Reactive species are formed by an electrical discharge between two electrodes, where molecules are bombarded with a flow of electrons.

From a macro perspective, a plasma state is formed by electrons and heavy particles. Heavy particles include reactive species, molecules, atoms, radicals, and ions. Electrons are smaller, so they acquire a higher velocity, and reach higher temperature easily. When the electric field is formed, electrons collide with heavy particles, and tens to hundreds of reactions occur constantly. In ‘cold plasma’, the temperature of electrons is much higher than the temperature of heavy particles, therefore they are not in equilibrium and the whole system is maintained at room temperature. In contrast, ‘thermal plasma’ can achieve temperatures of 1000-10000° C. when the heavy particles heats up, and both electrons and heavy particles achieve thermodynamic equilibrium.

A plasma state is formed when a system gains enough energy to partially ionize a gas. The transition between a gas state and a plasma state is marked by an ignition point that involves a current increment because of a higher flow of electrons. At this point, atoms and molecules moves through different energetic states. Molecules absorb energy when they change from low to high levels, and release energy when they move from high to low energetic levels. In the latter, they emit light and form a uniform glow discharge.

Increasing the intensity of the electric field can change a uniform glow plasma into an unstable system with streamers, in that case the system changes from an insulating dielectric into a conductive medium. Arc filaments or streamers can reach a breakdown if the intensity of the electric field is increased. In cold plasma treatment, it is preferred to maintain a uniform glow discharge, and this state is controlled by gas composition, electrode configuration, dielectrics, and pressure [30]. The type of gas used is an important factor, for example helium gas requires less energy to form a uniform glow plasma compared to nitrogen gas. The differences between gases has been acknowledged by the value of Townsend breakdown, that determines the amount of energy required to reach a system breakdown. Parameters such as number of electrons, townsend breakdown, dissociation energy, and ionization energy are shown in Table 1.

TABLE 1
Properties of gases [31, 32]

| | No. of | Ionization | Townsend | Dissociation |
|---|---|---|---|---|
| Element | electrons | energy (eV) | Breakdown(kV/cm) | Energy (eV) |
| Nitrogen | 7 | 14.5 | 35 | 9.76 |
| Hydrogen | 1 | 13.6 | 20 | 4.48 |
| Argon | 18 | 15.8 | 2.7 | — |
| Oxygen | 8 | 13.6 | 30 | 5.12 |

Application of cold plasma. Cold plasma technology involves a combination of fields such as plasma physics, chemistry, and several areas of engineering. Plasma physics and chemistry are required for understanding the processes of transferring energy into a gas state, to pro-duce charged species and their chemical activity and physical interactions. Plasma engineering involve the design and development of plasma systems. All of which have been studied widely since the 18th century and provide a theoretical support for the underlying physics in the food decontamination process. Cold plasma have a wide range of applications in fields such as agriculture, medicine, materials, or environmental. The formation of reactive species are used to modify surfaces, oxidation reactions, and microbial reductions.

The application of cold plasma for microbial decontamination date back from the early 2000s, including applications in medicine. Since 2005, this technology has been studied extensively for the reduction of microbes in food, where there are a significant increment in scientific publications on the topic.

Cold plasma has been used to change surface properties, including cleaning, activation, and etching. As well as modifying specific characteristic such as surface composition by making them hydrophobic or hydrophilic. It can be used with differ-ent materials such as plastics, metals, clothing, ceramics, or food. Cleaning surfaces from lubricant residues, biofilms, or oxide layers, where reactive species break down molecules deposited in the surface, and turning them into volatiles.

Food Science.

The importance of cold plasma in the field of Food Science is about developing a technology that is highly reactive at low temperatures, since reactive species can decontaminate the surface of food without changing the physical properties, as it is done with high temperature. Additionally, reactive plasma species can change the chemical structure of nutrients by attaching moieties, breaking bonds, or cross-linking molecules, with the intention to obtain functional ingredients.

Cold plasma has been studied to decontaminate fruits, vegetables, cereals, meat, fish, and dairy products [33]. The mechanism for microbial inactivation using cold plasma is the production of reactive oxygen species (ROS) and reactive nitrogen species (RNS), such as ozone, hydroxyl, nitrous oxide, and others that causes oxidation of lipids, amino acids and nucleic acids [34, 35].

Plasma Chemistry.

Plasma is a state in constant movement, where electrons collide with atoms and molecules generating unique reactive species. A dielectric barrier discharge atmospheric pressure plasma was studied by modeling the reactions of helium and water (1-3000 ppm), and this study described 577 reactions and 46 different species [36]. The generation of plasma species is complex and involve continuous interactions be-tween molecules, atoms, ions and excited species. This process initiate by electron collisions.

Atoms and molecules acquire different electronic states by electron collisions, forming excited species (A*). In addition of electronic states, molecules also acquire rotational and vibrational excitation, increasing the complexity of the system. The main process of plasma generation is the formation of ions. Ionization occur when an electron is knocked off the atom or molecule. Ionization is an inelastic collision, where there is a change in the internal energy state of the atom or molecule.

Reactive species is the plasma field are formed not only from electron collisions, but also by reactions within each other, such as ion-ion, or ion-molecule. The result is a hundred of reactions that occur in seconds, including recombination, neutralization, fragmentation, or polymerization.

Identification of Reactive Species.

Reactive species from air include: reactive oxygen species (ROS), reactive nitrogen species (RNS), ultraviolet radiation, electric current, energetic ions and other charged species. ROS are identified as species with a high oxidation capacity. The main ROS include atomic oxygen, hydroxyl, hydrogen peroxide, and ozone. Molecular oxygen (O(3P)) acquires excited states, O(1S) and O(1D), and dissociate in atomic oxygen. Hydroxyl radical (OH) is formed from water, by electron impact dissociation. Ozone generation reactions require an energy of 6-9 eV, and it is formed by reactions of molecular and atomic oxygen [39].

RNS are formed from nitrogen, oxygen, and humidity. Molecular nitrogen is dissociated and react with oxygen, forming nitrogen oxides (NO, NO₂, N₂O₃, N₂O₅). Nitrogen oxides react with water forming nitric and nitrous acids (HNO₃ and HNO₂), and then decomposed to nitrate and nitrite (NO⁻³ and NO⁻²). These RNS have been attributed also to increase the nitrite content in water, plant extracts, and processed meat [40].

Plasma systems produce short and long lifetime species. The first type are species formed in the volume within the electrodes, known as direct exposure area. These species have an important function to kill microbes, however it is difficult to identify them because of their short lifetime. Optical emission spectroscopy has been used to identify the wavelength emitted by this species in the range of UV-VIS spectrum. Allowing to recognize excited species (A*), that emit photons when they move to a lower energy state. For example in atmospheric air, there are strong lines in the 300-425 nm wavelength range, identified as transitions of second positive system of N₂, first negative system of N⁺, NO, and OH.

The long lifetime species can be identified when the source of energy is disconnected. These species are frequently analyzed by optical absorption spectroscopy, mass spectroscopy, or sampled for further analysis. The main long live specie that has been studied is ozone that can reach levels of 100-10000 ppm of ozone [41]. High concentrations of ozone have been detected until 24h after treatment in sealed pack-ages. Detailed examination of long lifetime plasma species studied by Judee et al (2018), showed the quantification of 11 species by colorimetric methods (ammonia, ammonium, orthophosphates, nitrites, nitrates, hydrogen peroxide), titration (carbonate ions), and pH measurement [42].

Nitrogen and hydrogen gas. The applications of cold plasma in Food Science at the moment have been focused in reducing the microbial load. For such application, air has been the main gas used because it is necessary to produce ROS and RNS to inactivate microorganisms. On the contrary, in the present study oxidation reactions are avoided. Therefore, the gases that were used in this study include nitrogen, hydrogen, and argon. Table 2 include energy values of excitation, dissociation, and ionization reactions. Hydrogen gas requires a higher energy to dissociate or ionize in comparison with nitrogen gas.

TABLE 2
Electron impact ionization energy and cross sections

| | | | |
|---|---|---|---|
| | | | Cross sections |
| Name | Reaction | Energy (eV) | (10⁻¹⁶ cm²) |

NITROGEN [43]

| | | | |
|---|---|---|---|
| Electronic | N₂ | 7.7 | 0.005 |
| excitation | | | |
| Dissociation | N | 14 | 0.04 |
| Ionization | N ⁺ | 30 | 0.0325 |
| Ionization | N ⁺⁺ | 70 | 0.0002 |

HYDROGEN [44]

| | | | |
|---|---|---|---|
| Electronic | H₂ | 13.6 | 0.046 |
| excitation | | | |
| Dissociation | H | 9 | 0.044 |
| Ionization | H⁺ | 30 | 0.0086 |

WATER [45]

| | | | |
|---|---|---|---|
| Dissociation | OH + H | 5.1 | — |
| Dissociation | OH + H* | 15.3 | — |
| Ionization | OH⁺ | 17.5 | 0.0013 |

Cold plasma has been used to hydrogenate silicon and thin films, where hydro-gen gas was the source of atomic hydrogen added into the molecules [46-49]. The hydrogenation of silicon by a surface reaction of atomic hydrogen generated upon non-thermal plasma has been reported [47].

Nitrogen fixation by cold plasma treatment have been studied recently, for applications such as nitrogen fixation, ammonia and nitrate production [50]. The Haber-Bosch reaction is an energy extensive process to generate ammonia. Cold plasma has been investigated as a technology to produce ammonia with a reduced reaction temperature and pressure. The high energy species from nitrogen and hydrogen gas can be used to ammonia synthesis in the presence of magnesia catalyst [51].

Effect of Humidity.

The role of humidity in the generation of plasma is important, because water molecules dissociate and produce a large number of reactive species, see Table 3. These species include positive and negative ions, as well as excited states, radical, and neutral species. Also, metastable species that can be detected after plasma treatment. The generation of hydrogen peroxide, hydroxyl radicals, and atomic oxygen has been demonstrated in literature [52]. These species play an important role in microbial decontamination.

TABLE 3
Reactive species generated from water [36]

| Name | Reactive species |
|---|---|
| Positive ions | H⁺, O⁺, OH⁺, H₂O⁺, H₃O⁺ |
| Negative ions | H⁻, O⁻, OH⁻, H₃O2—, H₅O3— |
| Metastables | O(1D), O(1S), O₂, OH |
| Ground state | H, O, H₂, O₂, OH, OH₂, H₂O₂ |
| neutrals | |

Equipment.

There are different sources to generate a partially ionized a gas, according to power characteristics and electrode geometries. The common source of energy is electricity for most of plasma systems, with different voltages and applied frequencies. Plasma sources are classified according to electrode configurations as: dielectric barrier dis-charge, plasma jet, corona discharge and microwave plasma.

Dielectric Barrier Discharge.

Atmospheric cold plasma is generated mostly with dielectric barrier discharge (DBD) systems. DBD generate a plasma glow between two electrodes separated by a given distance. The main electrode is connected to the energy source, while the other electrode is grounded. The gas volume between electrodes is submitted to an electrical field, forming a plasma state if the energy surpasses the ignition point. Voltage reported in literature range from 5-90 kV, and frequency from 50/60 Hz to 1-60 kHz (low radio frequency). Typical materials used for electrodes are copper, or aluminum.

An important characteristic of DBD is the addition of a dielectric material, which covers one or both electrodes. The function of the dielectrics is to maintain a uniform plasma glow by preventing arc formation and distributing streamers through the surface. Common materials used as dielectric barriers are teflon, plastic, glass, or ceramic.

In-package DBD is a system designed to treat food on its final packaging material. It includes three types of configurations. The first setup creates a plasma state between two external electrodes, that are at the top and bottom of the package. The second and third setup create a plasma through pairs of electrodes, placed across one side of the package. The difference between them is that the electrode can be embedded in the package or outside the package [33].

Cold Plasma and Lipids.

The reactions associated with oils and fats degradation are mainly: oxidation, hydrolysis, and polymerization. These reactions occur during improper storage or processes with high temperature, and the results are notable by changes in physical (color, density, viscosity) and sensory properties. As it was mentioned before, cold plasma has been studied mainly as a technology to reduce microbial load. In this matter, the information available is mostly related to lipid oxidation, where air or oxygen gas mixtures are used to treat food. However, the creation of reactive species that do not involve oxygen have only been studied as a processing aid to create lubricants from vegetable oil polymerization.

Lipid Oxidation with Cold Plasma Treatment.

Lipids are susceptible to oxidation, especially foods with a high content of unsaturated fatty acids, carotenoids, and volatile or essential oils. Herbal spices are rich in lipids that easily oxidize. Atomic oxygen can have two orders of magnitude higher in oxidation rate than molecular oxygen, it reaches the double bonds of unsaturated fatty acids, which is the target to initiate lipid oxidation [58].

Cold plasma treatment accelerate lipid oxidation of oils and fats rich in double bonds, specially when they are exposed to extended periods of time using oxygen in the plasma chamber. Fish fillets (mackerel or herring) that are rich in unsaturated fatty acids treated with cold plasma showed high levels of oxidation [59, 60]. Peroxide value increased up to 37 meq/kg of lipids in 5 min treated mackerel fillets, indicating the formation of primary oxidation products. T-bars increased to 0.53 mg of MDA/kg after cold plasma treatment and 6 weeks of storage, with a detectable off flavor of lipid oxidation. In contrast, products rich in saturated fatty acids, such as milk, beef, or nuts, are less susceptible to lipid oxidation. A cold plasma treatment of beef and dairy products increase the oxidation rate but without significant changes [61]. Hazelnuts, peanuts and pistachios treated with cold plasma can reduce the microbial load by 5 log₁₀ of Aspergillus parasiticus, and 50% of total aflatoxins [62]. Sensory properties such as color, odor, texture and appearance, were not significantly different after a 20 min treatment. Milk fat contain 64% of saturated fatty acids and no changes in lipid composition were detected after a 20 min treatment with a corona discharge at 20 kV [63].

Monitoring Oxidation with Cold Plasma.

Oxidation is a parameter often used as a marker of shelf life of food products. Current methods of analysis, are criticized because they do not reflect the natural exposure of food to ambient conditions. Accelerated tests are based in the exposure of food to high temperature of storage, producing much higher concentrations of oxidation products, which is not the real conditions of storage. Cold plasma has been studied as an accelerated method of analysis for lipid oxidation at room temperature, using a plasma jet at 6-15 kV for 60 min [64-66]. The authors of these studies identified specific aldehydes and ketones that can be used as markers to monitor lipid oxidation. For example, nonanal is an aldehyde that has been identified as a secondary oxidation product of unsaturated fatty acids with 18 carbons, even if they have 1, 2, 3, or 4 double bonds. This aldehyde is formed by the scission of the C9 double bond. The nonanal content for fish oil stored for 11 weeks (natural aging) is 16.8%, with an accelerated test (rancimat, 6h/100° C.) it reaches 381.9 ug/g. A cold plasma treatment of 60 min with air/O₂, generate 28.1 ug/g of nonanal [64]. The measurement with cold plasma is similar to a natural aging oxidation, performed in a lower time than the accelerated method. Another experiment was done with oleic acid, which is a fatty acid more stable to oxidation than fish oil. Results of a natural oxidation aging test of oleic acid stored for 15 weeks at room temperature, increases from 0.56 to 17.91 ug/g. In contrast, with a cold plasma treatment of 60 min (Ar/oxygen in Ar atmosphere), it reaches 12.88 ug/g [67]. In these studies, the authors concluded that there is a correlation between natural aging oxidation and cold plasma accelerated oxidation, by the formation of volatiles that are used as markers that may determine shelf life of food products.

Experimental Procedure

Soybean Oil.

Soybean oil Kroger brand was purchased from a local supermarket (Kroger, USA) and stored at room temperature (20-22° C.) prior to use. A volume of 10 ml was filled in a plastic (polypropylene) container (104×125×30 mm). This container was placed inside the plasma chamber.

HVACP Set Up.

The HVACP system utilized a transformer BK-130 (Phenix Technologies, Accident, MD) with an electrical energy input voltage of 120V (AC) at 60 Hz. The BK-130 unit has the capacity to deliver a high voltage output up to 130 kV. A polypropylene plastic container (370×355×52 mm) was used as the treatment vessel (model 9100AB, Artbin, Middlefield, Ohio). The container was placed inside a B2630 high barrier film (Cryovac Sealed Air Corporation, NJ) to maintain the gas inside the container. The oil sample was positioned in the center of the container (direct field exposure). The container (volume 6.8 L) inside the B2630 film was then purged with the selected gas using a flow rate of 10 L/min for 3 min and then sealed. Preliminary experiments confirmed this gas flushing process reduced oxygen content to below 0.5% inside the container. Two circular shaped aluminum electrodes (150 mm diameter) were placed on the top and bottom of the container along with two additional dielectric layers (acrylic sheets 315×380×6 mm). The two dielectric layers were between the electrode and the container on the upper and lower side to provide stability to the plasma discharge inside the container. The plasma experiments were performed at 90 kV for a treatment batches of 2 h, and up to 12 h total with a power setting of 200W. The initial temperature of the oil was room temperature (20-22° C.), however after 2 h of treatment it increased maximum to 60° C.

Gas Composition Inside the Plasma Chamber.

Two gases were used in the experiments, HN gas blend (5% hydrogen/95% nitrogen) and H gas (100% hydrogen). They were purchased from American Welding Inc., Billings, Mont. Hydrogen gas is highly flammable in a concentration above 5% in air [88]. Thus, the HN gas blend was selected to avoid potential of ignitability, especially for treatments that involve treatment periods longer than 2 hours. HVACP treatments times of 2 h showed an increase in temperature up to 60° C. The current set-up was limited to operating temperatures below 80° C., as dielectric materials start to degrade. OES measurements with 100% hydrogen gas were only performed for 90 minutes to identify hydrogen species. The set-up for hydrogen gas included inserting the experimental setup into a 100% nitrogen gas enclosure to maintain the electrodes (located outside of the plasma treatment container) in an oxygen free environment.

Seven samples of soybean oil were treated with HVACP for 0, 1, 1.5, 2, 4, 6 and 12 hours. The samples were located in direct field exposure, flushed with HN gas, and then treated with HVACP. Direct plasma exposure is where the soybean oil is placed inside the treatment container between the electrodes. All experiments were replicated three times. Optical emission spectroscopy (OES) measurements were collected on the plasma field produced. Iodine Value (IV), fatty acid composition, and viscosity measurements were collected on the HVACP treated soybean oil samples, and compared to non-treated control samples.

Iodine Value.

Iodine value was determined according to AOCS official method Cd 1b-87 [89]. Treated and untreated soybean oil samples were maintained in a water bath at 40-45° C. for 15 minutes, and mixed vigorously to allow for homogeneous sampling. A sample weight of 0.22-0.26 g was dissolved with cyclohexane (20 ml). Standard iodine solution (25 ml) according to Wijs 0.1N (Acros organics, Belgium) was added in excess to halogenate double bonds, and stored in darkness for 1 h. The remaining iodine monochloride from Wijs solution was reduced with potassium iodide (20 ml) to free iodine and measured by titration with a known concentration of sodium thiosulfate. Iodine value was calculated from the weight of sample and volume of sodium thiosulfate.

Fatty Acid Composition.

Fatty acid composition was determined according to AOAC Official Method 996.06 (AOAC, 2005). Fatty acids methyl esters were obtained by derivatization with a solution of 3M hydrochloric acid in 3N methanol (Sigma-Aldrich, St. Louis, Mo.) as described by Kiefer [25]. Analysis were performed in a gas chromatograph (Hewlett Packard model 5890, Palo Alto, Calif.), using a polar ionic liquid column SLB-IL60 30 m×0.25 mm×0.20 um (Sigma-Aldrich, St. Louis, Mo.) with a flame ionization detector (FID) at 260° C. Helium was used as the carrier gas with a flow rate of 1.2 ml/min and a pressure of 60 kPa. The column temperature was programmed from 40° C. to 280° C., at a heating rate of 5° C./min. Injection volume was 1 ul, with a split mode 100:1. An external fatty acid standard was used to identify components, Supelco 37-component FAME (fatty acid methyl ester) mix 10 mg/ml (Sigma-Aldrich, St. Louis, Mo., USA). Dodecanoic acid (Sigma-Aldrich, St. Louis, Mo.) was added as an internal fatty acid standard for quantification measurements.

Viscosity.

Viscosity measurements were performed in a rotational rheometer (Discovery model HR-3, TA Instruments, New Castle, Del.). A sample volume of 1 ml was measured at room temperature (25° C.), with a plate diameter of 40 mm that provide an operated gap of 1000 um. The reported viscosity values were taken with a shear rate of 5-95s⁻¹.

Optical Emission Spectroscopy.

Plasma emission spectra was scanned using a high resolution spectrometer (Ocean Optics, model HR2000+, Dunedin, Fla.) equipped with a 1000 m optical fiber in the range of 200-1098 nm to monitor UV, VIS, and IR wavelengths. The distance between the optical fiber and the plasma chamber was 140 mm. The OES spectra were corrected for background noise and recorded each 30 sec. for a time-lapse of 90 min for a total of 180 spectra. These were then averaged (six spectra) over each fifteen minute time period. The spectra was recorded for H and the HN gas blend. The latter was recorded with and without a sample of 10 ml of soybean oil. The OES peaks were compared and identified with NIST Atomic Spectra Database [87].

Experimental Arrangement.

HVACP treatment is classified as a dielectric barrier discharge (DBD) system. It is comprised by two aluminum parallel electrodes (150 mm diameter) located above and below a sealed box. A high voltage 40-130 kV is supplied from a transformer (BK-130 model, Phenix Technologies, Accident, MD), that create an electric field between electrodes, and partially ionize the gas contained between them. The electrical input of the system is 120V (AC) at a frequency of 60 Hz. A sample was introduced inside a box (370×355×52 mm, model 9100AB, Artbin, Middlefield, Ohio), or plasma chamber. Then, filled with gas, and sealed with a high barrier film (B2630, Cryovac Sealed Air Corporation, NJ). Two dielectric layers (acrylic sheets, 315×380×6 mm) were placed at the top, and bottom side of the box. The dielectric layers were used to safeguard a steady plasma state, and avoid electric breakdowns. The experiments were done at 80-90 kV.

Experimental Design.

Kroger brand Soybean oil was purchased from a local supermarket (Kroger). A sample (5 g) was placed inside the plasma chamber, between the electrodes for a direct plasma treatment. Four samples of soybean oil were treated with HVACP for 0, 0.5, 1, and 1.5 hours, for each gas. Experiments were replicated three times.

Hydrogen and Nitrogen Gas.

The gases used to fill the box (plasma chamber) were: 100% nitrogen (100N), gas blend of 5% hydrogen/95% nitrogen (5H), gas blend 50% hydrogen/50% nitrogen (50H), and 100% hydrogen (100H). All gases were 99.995% high purity dry, and purchased from American Welding Inc. (Billings, Mont.). The box was flushed, and filled with the gases at a flow rate of 10 L/min for 3 min. This step was taken to evacuate the air inside the box, and have a uniform composition in all treatments. 50H and 100H were treated with a special set-up that included a nitrogen blanket which completely envelopes the electrodes eliminating oxygen, and reduce the risk of flammability of hydrogen gas [88].

Iodine Value.

Samples were heated in a water bath at 40-45° C. for 15 minutes, and then analyzed according to AOCS official method Cd 1b-87 [89]. Iodine value (IV) of solid samples were calculated with a formula according to AOCS official method Cd 1c-85 [89].

Fatty Acid Composition.

Samples of soybean oil were derivatized to fatty acid methyl esters (FAME) as described by Kiefer [25]. Then analyzed with gas chromatography according to AOAC Official Method 996.06 [101]. A gas chromatograph (Hewlett Packard model 5890, Palo Alto, Calif.) was used to analyze fatty acid composition, with a polar ionic liquid column SLB-IL60 30 m×0.25 mm×0.20 μm (Sigma-Aldrich, St. Louis, Mo.), and a flame ionization detector (FID) at 260° C. Helium was used as the carrier gas with a flow rate of 1.2 ml/min. The column temperature was programmed from 40° C. to 260° C., at a heating rate of 5° C./min. A sample volume of 1 μl was injected, with a split mode 100:1. Supelco 37-component FAME mix 10 mg/ml (Sigma-Aldrich, St. Louis, Mo., USA) was used to identify components, and dodecanoic acid (Sigma-Aldrich, St. Louis, Mo.) as an internal standard.

Nitrogen Content.

Nitrogen content was determined according to AOAC Official Method 968.06. The samples were analyzed by an external laboratory, A&L Great Lakes Laboratories (Fort Wayne, Ind.).

Nuclear Magnetic Resonance.

Analysis were performed on a Bruker Avance 500 MHz spectrometer. Spectra were acquired at 300K, observing 1H at 500.128 MHz, and processed with Topspin software package version 1.3. NMR samples were prepared by dissolving in approximately 0.6 ml of CDCl3+0.1% of TMS, and transferring the solution to a 5-mm NMR tube for analysis. Spectra were acquired using 16 scans, 32K data points, 90 pulse angle (10.5 μs), relaxation delay 1 s, acquisition time 2.47 s, and spectral width 13.2 ppm (6613.7 Hz). Spectra were accurately phased, and their baseline adjusted accordingly. TMS was used as internal standard, and chemical shifts were reported in ppm from TMS (δ=0).

Optical Emission Spectroscopy (OES).

Analysis were done in a high resolution spectrometer (Ocean Optics, model HR2000+, Dunedin, Fla.), with a 1000 μm optical fiber (200-1098 nm, UV-VIS-IR wavelengths). The detector was located at 140 mm from the box. The OES spectra were corrected for background noise, and recorded each 30 s for a time-lapse of 90 min. The spectra were collected for all gases, and a total of 180 spectra on each gas. OES peaks were compared, and identified with NIST Atomic Spectra Database [87].

Samples.

Three samples were treated with high-voltage atmospheric pressure cold plasma (HVACP): (a) soybean oil, (b) linolenic acid, and (c) trilinolein. Refined soybean oil (10 g) from a local supermarket was treated for 4 h with three gases: nitrogen (99.995% purity), hydrogen (common grade, 99.8% purity), and argon (common grade, 99.997% purity), by triplicate. An 80-100 mg sample of pure linolenic acid standard (>99% purity, Nu-check, Elysian, Minn.) was treated with HVACP using ni-trogen, hydrogen, and argon gas. The gas atmosphere inside the plasma chamber had a relative humidity level of 22% that corresponds to an absolute water concen-tration of 4.03 ppm (room temperature 21±1° C.) as a result of a 5 min gas flushing. Relative humidity was measured inside the plasma chamber after 10 min of sealing the bag with a hygrometer (Traceable, Fisher Scientific) with a resolution of 1%. In addition, oxygen content after a 5 min flushing was less than 0.3%, measured with a gas analyzer (MOCON Inc., Minneapolis, Minn., USA). An 80-100 mg sample of pure trilinolenin (>99% purity, Nu-check, Elysian, Minn.) was treated with argon gas under low and high humidity. The high humidity set-up was obtained by bubbling argon gas through distilled water before entrance into the plasma chamber, reaching a relative humidity level of 63% inside the plasma chamber, that corresponds to an absolute water concentration of 11.6 ppm (at room temperature).

HVACP Treatment

Samples were introduced into the plasma chamber (polypropylene box with the dimensions 175×275×44 mm, Artbin, Middlefield, Ohio) filled with gas at a flow rate 1 L/min, flushed for 4 min and sealed with a high barrier flexible film cryovac bag (Sealed Air Corporation, NJ). The oxygen transmission rate for this film was 1.5-3.5 cm³/(m²-24h-1 atm) at 5° C.-0% RH. The moisture vapor transmission rate was 0.3-0.6 g/(100 in²-24 h-1 atm) at 38° C.-100% RH. The plasma chamber was exposed to a strong electric field (80 kV, 150 200 W). The energy was supplied by a transformer (BK-130 model, Phenix Technologies, Accident, MD) that converted a source of 60 Hz/120 V AC into 0-130 kV energy output. Two polypropylene layers were placed above (4.4 mm thickness) and one polypropylene layer below (2.2 mm thickness) the plasma chamber as additional dielectric barriers.

Fatty Acid Composition.

Soybean oil was derivatized to fatty acid methyl esters (FAME) as described by Kiefer [25]. The fatty acid composition was measured by gas chromatography with flame ionization detector (Shimadzu, GC-2010, Japan), according to AOAC Official Method 996.06 (AOAC, 2005). Under the following conditions: polar ionic liquid capillary column SLB-IL60 (Sigma-Aldrich, St. Louis, Mo.) temperature from 150° C. to 280° C., at a rate of 5° C./min. Split mode 50:1. A mixture of 37 FAME standards (Supelco 37-component FAME mix, Sigma-Aldrich, St. Louis, Mo., USA) was used for the identification of the fatty acid methyl esters and an internal standard (dodecanoic acid, Sigma-Aldrich, St. Louis, Mo.) was added for quantification.

Mass Spectrometry.

A linear quadrupole ion trap mass spectrometer coupled with a high-resolution orbitrap detector (LTQ-Orbitrap XL, Thermo Scientific, Waltham, Mass.), equipped with an electrospray ion source (ESI), was used to analyze untreated and treated samples of linolenic acid and trilinolenin. Thermo Xcalibur 2.2 software was used to identify HVACP reaction products and determine their molecular weights. Linolenic acid was dissolved into 50:50 acetonitrile/water solution at a concentration of 0.5 mg/mL and then directly injected into the (−) ESI source at a 15 1/min flow rate. Trilinolein was dissolved into 50:50 methanol/chloroform solution at a concentration of 0.5 mg/mL and doped with ammonium formate at 0.1 mg/mL, and then directly injected into the (+)ESI source at a 15 l/min flow rate. ESI source conditions were as follows: spray voltage 4.5 kV, nitrogen sheath gas flow rate: 30 arbitrary units, auxiliary nitrogen gas flow rate: 15 arbitrary units, temperature 250° C.

Fourier Transform Infrared Spectroscopy (FTIR)

A Nicolet 470 spectrophotometer (Thermo Fisher Scientific, MA) equipped with a MCT detector was used to collect FT-IR spectra with a resolution of 4 cm⁻¹ by using 128 scans. The samples were deposited directly onto the Attenuated Total Reflectance (ATR) crystal, where the sample formed a thin film to cover the surface. Duplicate absorbance mode spectra were recorded from 4000 down to 800 cm⁻¹ and processed with Omnic software.

Statistical Analysis.

The fatty acid composition results obtained for soybean oil were subjected to statistical analysis. Significant differences were detected among mean values with Duncan multiple range test, using SAS 9.4 software with a confidence level at P<0.05. Mean values and standard errors are reported.

Results and Discussion

Traditional soybean oil hydrogenation using 150-235° C. temperature, 1-3 atm pres-sure, and 0.01-0.08% nickel catalyst requires 1-4 h to achieve a reduction in IV from 130 to 90 [6, 73]. HVACP hydrogenation achieved a reduction in IV from 131 to 92 in 12h treatment (Table 4). This reduction in IV is of a similar as the commercial partially hydrogenated soybean oil.

TABLE 4
Iodine value of soybean oil treated with
HVACP at 90 kV on direct field exposure, using
a gas blend of 5% hydrogen/95% nitrogen
(NH) in a container with a gap of 52 mm.

| Treatment Time | |
|---|---|
| (h) | Iodine Value |
| 0^{a} | 130.9 ± 1.3 |
| 1^{a,b} | 127.4 ± 1.4 |
| 1.5^{a,b} | 127.4 ± 1.4 |
| 2^{b,c} | 124.8 ± 1.4 |
| 4^{c} | 118.4 ± 1.8 |
| 6^{c} | 107.5 ± 1.3 |
| 12^{d} | 91.9 ± 1.6 |

Changes in fatty acid composition over treatment time are correlated with the reduction in iodine value. Linolenic (18:3) and linoleic (18:2) acid significantly decrease during treatment time, while oleic (18:1), stearic (18:0) and palmitic (16:0) acid significantly increase. In 2003, Karabulut et al. reported a traditional soy-bean oil hydrogenation process at 220° C. from an IV of 133.6 to 90, that resulted in a reduction of 33% polyunsaturated fatty acids (18:3 and 18:2), formation of 36.8% of trans fatty acids (18:2t and 18:10, and a small increment of 3.1% of saturated fatty acids [75]. In contrast, HVACP treatment of HN working gas is characterized by a significant, 11.6% increase, in saturated fatty acids without the formation of any trans-fatty acids found in the traditional hydrogenation process. The 2 h HVACP treatment achieved a 22% of saturated fatty acids with an IV of 124.5, equivalent to a PHO with a saturated fatty acid content of a soybean oil with an IV of 108 using the traditional hydrogenation process [75]. In HVACP treatment total saturated fatty acids content increased to 27.5% and 32.3% after 6 h and 12 h, respectively.

PUFA (polyunsaturated fatty acids) decreases from 57.7% to 41.5%, with a 12 h HVACP treatment. This reduction involve changes of 18:3, from 9.5±0.4% to 3.7±0.4%, and for 18:2 from 48.2±0.4% to 36±0.5%, both are significantly less compared to the untreated soybean oil. The reduction of PUFA in a traditional hydrogenation process promotes the formation of trans-fatty acids. Trans-isomers are created from the isomerization of 18:1 and 18:2, as a consequence of high temperature, and the use of nickel catalyst [5]. Note: The nickel catalyst must also be removed after hydrogenation as it is toxic. In HVACP treatment of soybean oil at room temperature and atmospheric pressure with a HN working gas, o acid (18:2 9t, 12t) and elaidic acid (18:1 9t) were not detected. However, a new peak (a-component) was observed with a 1.9±0.4% of total oil content with a 12 h HVACP treatment, this is 20 times less than 35-40% of trans-fatty acids reported in a traditional PHO with similar iodine value [6, 75]. Its retention time was between the peaks of 18:1c and 18:2c. It likely is an isomer of 18:2 due to the retention time; however, this component could not be identified within the 37-FAME standard. Elaidic acid (18:1t) elutes before 18:1c. Linolelaidic acid (18:2 9t,12t) elutes at 41.46 min, and a-component at 41.37 min. Isomers such as 18:2 9c,12t or 9t,12c elute between 18:2 9t,12t and 18:2c, and not before, study of this new component is underway.

HVACP treated soybean oil samples treated up to 6 hours exhibited Newtonian behavior with viscosity increasing from 0.05 to 0.23 Pa's, same as the untreated soybean oil. HVACP treated soybean oil samples treated for 12 h showed a non-Newtonian behavior in which viscosity decreased as the shear rate increased, from 11.7 to 2.4 Pa's at a shear rate of 5-95 s⁻¹, behaving with a Casson model with a R²=0.9915. An increment in saturated fatty acid content changes the physical properties of a vegetable oil, increasing its viscosity as a hardening effect similar to a solid fat. The characterization of the plasma species are necessary to understand the energy levels required to carry out the HVACP hydrogenation reaction. It is hypothesized that energy levels of hydrogen species increase over time in HVACP treatment. In a plasma reactor, electrons collide with molecules, and they separate into atoms. Hydrogen gas (molecular hydrogen) breaks apart in two hydrogen atoms (atomic hydrogen), by dissociative excitation (2.4) with electron impact [90]. This reaction require 15 eV (cross section of 1.4×10⁻¹⁶ cm²) [91].

H₂+e→e+H+H (2.1)

In a traditional hydrogenation process, the source of hydrogen atoms is obtained by the adsorption of molecular hydrogen in the catalyst surface. The catalyst reduce the activation energy of the reaction by facilitating the contact between the hydro-gen atoms and double bonds. Thus, an advantage of HVACP is to shift the electron energy distribution to a higher mean electron energy, and increase the generation rate and concentration of atomic hydrogen. In 2012, Connolly et al described a helium/air plasma treatment similar to HVACP system, using 15 kV at 50 Hz with an electron temperature of 4980 K, and electron density of 1.0×10¹⁷ m⁻³ [92]. Andre and co-workers (2001) studied a method to determine the composition of hydrogen and nitrogen plasmas at atmospheric pressure, they established that nitrogen gas dissociate and ionize at 6000-6500 K in a higher rate, in contrast with hydrogen gas that dissociate and it doesn't ionize until it reach a higher electron temperature [93]. Therefore, hydrogen gas is more difficult to ionize compared to nitrogen gas, due to nitrogen containing a larger number of electrons in the outer shell. Nitrogen species have higher intensity than hydrogen at the same voltage (90 kV). Assuming the same values of electron density (6000-6500 K) for HVACP treatment, it is suspected that hydrogen gas is dissociated into hydro-gen atoms, while nitrogen is dissociated and ionized. Hydrogen atoms are therefore available to react with unsaturated fatty acids.

Differences were observed in the OES spectra from HVACP treatment with NH gas blend, when oil was present. Specifically, the presence of soybean oil during HVACP treatment showed a reduction of species A (367.54 nm) and species B (398.45 nm) from 23.9 to 8.2, and 148.1 to 65.1, respectively. This reduction suggests that these atomic hydrogen species were consumed by the HVACP hydrogenation reaction of soybean oil. It is suspected that hydrogen species A and B, have the energy required to modify the double bonds of unsaturated fatty acids, increasing the saturated fatty acids of a HVACP soybean oil.

Iodine Value (IV).

IV is a measurement of unsaturation degree, and reductions in IV reflect a decreasing number of double bonds that occur mainly in a hydrogenation reaction, where hydrogen saturate a double bond into a simple bond. Results showed a reduction of IV when samples were exposed to longer treatment times. Reductions of IV at 1h treatment were significantly different in all gas mixtures (122.8-129.2IV) compared with untreated soybean oil (1330.6 IV), but they were not different between each other. Treatments at 1h (129 IV) and 1.5 h (127 IV) with 100H gas, showed less reduction in IV, compared with other gases. Samples treated for 1.5h with nitrogen gas (100N, 5H, 50H) have similar IV, in a range of 122-123. For gas blends 5H and

50H, IV decreased rapidly from 0.5h to 1h. Reductions in IV from HVACP treatment of soybean oil are small compared to a commercial PHO oil that reaches an IV of 80-100. However, it has been shown that HVACP can reach those levels with longer treatment time [102]. Further improvements in HVACP treatment will be needed to reach commercial values of IV in shorter times.

Based upon results, the presence of nitrogen and hydrogen species lead to chemical modification of soybean oil. Hydrogenation is the main reaction associated with the reduction of IV. Nevertheless, oxidation and polymerization are also reactions that may lead to a reduction of double bonds. Oxidation create re-arrangements of double bonds, and serial reactions that ends up in the cleavage of hydrocarbons chains. Polymerization occur when two fatty acids are joined by a crosslink, that may occur between double bonds, in this way there is also a reduction of the number of double bonds [15].

Fatty Acid Composition

Samples exposed to nitrogen and hydrogen gas species change the fatty acid com-position of soybean oil. According to results, fatty acids with higher number of double bonds reduce, while saturated fatty acids increase with longer treatment times. This ‘solid sample’ was an additional analysis done with a small volume of oil (4-5%), that was solidified at the top of the box. It is possible that the intensity of the electric field was high enough to physically move the sample within the container, and reach the top of it, leaving it more exposed to plasma species. It is known that cold plasma is a surface treatment [103], sample in the surface will interact with highly energized plasma species, and may react in less time than the bulk sample. This ‘solid sample’ was a minimal amount generated for each treatment, and was characterized by a semisolid-gel texture. ‘Solid samples’ from 0.5, 1, and 1.5 hours were combined for fatty acid composition testing on each gas/replicate.

The fatty acid composition for the solid samples showed the same tendency as the liquid samples, meaning a reduction of PUFA, and an increment in SAT. The IV of solid samples obtained from the fatty acid composition, showed values of 90-100, like a commercial PHO. A notable difference in 18:0 and 18:1 content was found between traditional PHO, and solid sample. For 18:1, HVACP treatment showed a low increment (2.3-4.4%) for all gases, whereas PHO increases in approx. 26%.

On the other hand, HVACP treatment increases 18:0 content by 5.7-11.7%, whereas PHO increases just 1-2%. HVACP treatment may increase the saturated fatty acid content, instead of creating trans-fatty acids as the traditional hydrogenation process. Therefore, the main difference between HVACP soybean oil and PHO is the absence of elaidic acid (18:1-9t).

Trans-fatty acids were not detected in samples treated with 100N and 100H for 1.5h. For samples treated with 5H and 50H, it was found a small amount of linoelaidic acid (18:2 9t,12t), 1.53±0.53%, and 1.02±0.48%, respectively. This amount is low compared to the traditional catalytic hydrogenation, where a PHO with an IV of 90 contains 36.8% trans-fatty acids, mostly as elaidic acid [75]. HVACP treatment under these conditions still produced a greater than 95% reduction in trans-fatty acids. The formation of trans-fatty acids in a traditional, high temperature, catalytic hydrogenation is primarily the result of the absorption and desorption of double bonds in the catalyst surface, acquiring a trans-isomer position. Molecular hydrogen gas is bubbled in the oil, and it is separated into atoms by the effect of the catalyst. These atoms get in contact with the double bonds of unsaturated fatty acids, react together and form intermediate states that not only achieve hydrogenation, but also convert cis-into trans-configurations [5, 6]. This isomerization reaction produces elaidic (18:1, 9t) acid, and linoelaidic acid (18:2t, 9t,12t). HVACP treatment change the fatty acid composition, but there is a small quantity of trans-isomers. Therefore, the mechanism of the reaction between unsaturated FA and hydrogen species allow the formation of a simple bond, without the absorption/desorption process of the catalytic hydrogenation.

It shall be noted that there was a non-soluble fraction in the ‘solid samples’, that corresponds to a 30-40%. The presence of hexane (solvent) insoluble compo-nents may be related to the formation of polymers, and this may have a relationship with the increased amount of 16:0. A hydrogenation reaction alone will not change 16:0 composition, because there are no detected unsaturated fatty acids with 16 carbons in untreated soybean oil. A significant difference of 16:0 was detected in solid samples treated with four gases. Zhao and collaborators, studied the effect of cold plasma in soybean oil to obtain a lubricant with improved tribological properties, using nitrogen gas and air [68, 69]. They reported the formation of nitrogen hetero-cyclic structures, and polymers. Thus, it is possible that unsaturated FA may form polymers by crosslinks between double bonds that may not be soluble in hexane.

Nitrogen Content

Nitrogen gas was used initially as an inert gas to reduce the risk of flammability of hydrogen gas. However, samples treated with nitrogen gas acquired a yellow color, in contrast with samples treated with pure hydrogen gas. Results showed an increased content of nitrogen in samples treated with 100N and 5H gas for 1.5h experiments, however this dissimilarity was not significantly different compared with other samples. Color changes may be attributed to nitrogen fixation. Based upon results, it is suspected that nitrogen species are absorbed by the oil, reacting with double bonds of unsaturated fatty acids [21]. Nitrated fatty acids were not detected with GC or 1H-NMR. Both analysis require the use of a solvent, which are hexane and chloroform, respectively. In both solutions, an insoluble fraction was observed, that may be attributed to nitrated or polymerized compounds. Seemingly, the nitrated compounds are not soluble in these solvents, and therefore not detected by GC or 1H-NMR.

Results and Discussion

The in-package configuration of HVACP treatment allows the use of any type of gas inside the plasma chamber. In this study, nitrogen, hydrogen, and argon gas were used to treat samples. Hydrogen gas is flammable. For this reason, a nitrogen gas blanket was created around the electrodes in order to isolate them from air. The electrodes were separated by a gap of 44 mm, and a voltage of 80 kV was used for all experiments. Therefore, the current and power depend on the gas. For nitrogen, hydrogen, and argon gas, the current was 0.40-0.45 mA, 0.60-0.64 mA, and 0.70-0.78 mA, respectively. A uniform glow with random microdischarges was observed during treatment. The microdischarges were connected between the electrodes, and they are weakly ionized channels with a high current that may form sparks. For this reason, the dielectric layers allow to maintain a uniform plasma and thereby avoiding the formation of a spark breakdown [31].

Table 5 shows the fatty acid composition and iodine and peroxide values measured for untreated soybean oil and soybean oil exposed to HVACP under different conditions. These results demonstrate that the fatty acid composition changed upon all the treatments. A reduction of iodine value was observed for all treated samples. These values are in the range of 121-127, with the nitrogen treated sample having the lowest value. A commercial partially hydrogenated oil has an iodine value between 80-90, from soybean oil treated at 180-230° C., with nickel as a catalyst and hydrogen gas [6,75]. A further treatment with HVACP can reach these numbers [122]. However, in this study, a 4 h treatment of a 10 g sample was performed to identify statistically significant differences between untreated and treated soybean oils and to identify any differences caused by the different gases.

Changes in fatty acid composition included a reduction of the amount of the original unsaturated fatty acids, and an increased amount of monounsaturated or completely saturated fatty acids for the nitrogen treated sample. Nitrogen treated soybean oil contained increased amounts of saturated (4% by mass) and monounsaturated fatty acids (2.3% by mass), but reduced amounts of polyunsaturated fatty acids (6.3% by mass). Hydrogen treated samples contain the same amount of saturated fatty acids as the untreated soybean oil. However, they contained somewhat more oleic acid (1.7%) and slightly less linolenic acid (1.6%). Argon treated samples showed a similar composition as hydrogen treated samples. These results suggest that nitrogen gas is the most effective gas in HVACP treatment.

Linolenic acid (C18:3) and trilinolein were used as model compounds to identify the reaction products and delineate reaction mechanisms for HVACP treatment because the multiple double bonds in these compounds are susceptible to reactive species. The rate of catalytic hydrogenation of linolenic acid is known as 3 times higher than linoleic (C18:2), and 16-30 faster than oleic (C18:1) acid [1, 123]. The content of linolenic acid (C18:3) in soybean oil is 8-9%, and it nearly disappear in a catalytic hydrogenation [15, 75]. Similarly, the oxidation rate of linolenic acid (C18:3) is 14 times faster than linoleic acid (C18:2), and 100 faster than oleic acid (C18:1) [15]. Samples of linolenic acid (C18:3) were exposed for 1 h to HVACP at 80 kV with ni-trogen, hydrogen, and argon gas. The products were analyzed with ESI MS. Deprotonated linolenic acid of m/z 277 [M−H]⁻ was the most abundant ion observed for all treated samples. Ions of m/z 279 ([M+2H−H]⁻), m/z 281 ([M+4H−H]⁻), and m/z 283 ([M+6H−H]⁻) indicate the addition of 2, 4, and 6 hydrogen atoms into linolenic acid. These ions correspond to ionized linoleic (C18:2), oleic (C18:1), and stearic (C18:0) acid, respectively. The relative abundances of these ions are shown in Table 6. An increase in the relative abundance of linoleic acid (C18:2) was observed for all treated samples, being the largest for nitrogen, then argon, and the least for hydrogen treated samples. The nitrogen treated sample showed a relative abundance of 15.0% and 6.3% for oleic (C18:1) and stearic (C18:0) acid, respectively, compared to the relative abundances of these compounds being below 1% for the untreated sample. These results suggest that hydrogenation reactions had occurred at the double bonds of linolenic acid (C18:3).

HVACP treatment also led to the addition of oxygen to linolenic acid as indicated by the observation of ions of m/z 293.21, 295.23 and 297.24, corresponding to [M+O−H]⁻, [M+O+2H−H]⁻ and [M+O+4H−H]⁻, respectively. The [M+O−H]⁻ ion had the highest relative abundance for a sample treated with argon. Reactive oxygen species can be formed from impurities such as oxygen and water from gases, materials, or sealing method. Oxygen content in the plasma chamber before treatment was below 0.3%, however the oxygen transmission rate of the bag can be enhanced by the oxygen partial pressure difference between the inside and outside of the chamber over treatment. The relative humidity values inside the sealed plasma chamber are below 4 ppm, and it is difficult to reduce this value even with a longer flushing time because water molecules got absorbed in materials and filtrate during the sealing step. In fact, previous work showed the emission of hydroxyl radicals (305-313 nm) and atomic oxygen (775-778 nm) in the spectra of nitrogen and hydrogen gas with a HVACP treatment at 80 kV [52, 102]. The addition of oxygen by opening the double bond is attributed to an epoxidation. The mechanism of formation of epoxides may involve the direct addition of oxygen formed by electron impact dissociation. Another proposed pathway of oxygen addition involve the formation of a peracid, by a reaction between hydrogen peroxide and a carboxylic group [21, 124].

TABLE 5
Fatty acid composition (% by mass) of soybean oil exposed to HVACP
for 4 h at 80 kV while using nitrogen, hydrogen, and argon gas.
Monounsaturated fatty acids (MUFA), polyunsaturated fatty acids
(PUFA), total trans represent the sum of C18:1-9t and C18:2-9t,12t.

| Sample | Untreated | Nitrogen | Hydrogen | Argon |
|---|---|---|---|---|
| C16:0 | 12.6 ± 0.2^{a} | 14.3 ± 0.2^{b} | 13.2 ± 0.2^{a} | 14.0 ± 0.1^{b} |
| C18:0 | 5.2 ± 0.3^{a} | 7.5 ± 0.5^{b} | 5.7 ± 0.4^{b} | 5.4 ± 0.3^{a} |
| C18:1-9t | 0a | 1.6 ± 0.1^{b} | 0 ± 0.1^{a} | 0 ± 0.1^{a} |
| C18:1-9c | 20.3 ± 0.2^{a} | 20.7 ± 0.4^{ab} | 22.0 ± 0.3^{c} | 21.8 ± 0.2^{bc} |
| C18:1-11c | 1.6 ± 0.2^{a} | 1.8 ± 0.3^{a} | 1.0 ± 0.2^{a} | 1.5 ± 0.2^{a} |
| C18:2-9t,12t | 0 ± 0.1^{a} | 0 ± 0.1^{a} | 0.3 ± 0.1^{a} | 0 ± 0.1^{a} |
| C18:2- | 51.4 ± 0.6^{a} | 45.9 ± 1.0^{b} | 50.4 ± 0.8^{a} | 50.0 ± 0.6^{a} |
| 9c,12c | | | | |
| C18:3- | 9.0 ± 0.3^{a} | 8.2 ± 0.5^{ab} | 7.4 ± 0.4^{ab} | 7.2 ± 0.3^{b} |
| 9c,12c,15c | | | | |
| Iodine | 131.3 ± 0.7^{a} | 121.7 ± 1.0^{c} | 126.9 ± 0.9^{b} | 125.6 ± 0.6^{b} |
| Value | | | | |
| Saturated | 17.8 | 21.8 | 19 | 19.4 |
| MUFA | 21.8 | 24.1 | 23 | 23.4 |
| PUFA | 60.4 | 54.1 | 58.1 | 57.2 |
| Total trans | 0 | 1.6 | 0.3 | 0 |
| Peroxide | 0.73 ± 0.46^{a} | 3.97 ± 0.46^{b} | 2.18 ± 0.46^{ab} | 3.90 ± 0.46^{b} |
| Value | | | | |
| (meq/kg) | | | | |

^{ab}Values represent mean ± standard error of measurements made on three replicates.
Values within a row followed by the same superscript letter do not differ significantly (p > 0.05)

TABLE 6
Relative abundances of ions derived from compounds in untreated
linolenic acid and linolenic acid exposed for 1 h to HVACP
at 80 kV when using nitrogen, hydrogen, and argon gas.

| m/z | Compound | Untreated | Nitrogen | Hydrogen | Argon |
|---|---|---|---|---|---|
| 275.22 | C18:4 | 0.6 | 3.3 | 1.1 | 3.4 |
| 277.22 | C18:3 | 100 | 100 | 100 | 100 |
| 279.23 | C18:2 | 7.8 | 27.5 | 10.5 | 13.3 |
| 281.25 | C18:1 | 0.9 | 15.0 | 0.9 | 2.0 |
| 283.26 | C18:0 | 0.2 | 6.3 | 0.2 | 0.5 |
| 295.23 | C18H30O3 | 1.3 | 7.4 | 2.2 | 8.0 |
| 297.24 | C18H32O3 | 0.2 | 2.1 | 0.3 | 0.9 |

Changes in FTIR signal intensities confirm that reactions occurred upon HVACP treatment. The major peaks in FTIR spectra for a fatty acid are due to the presence of carbon-carbon double bonds (stretching of aliphatic alkenes, 3010 cm⁻¹), carbon-carbon simple bonds (stretching of aliphatic alkanes 2930 and 2830 cm⁻¹), and carbonyl group (C═O stretching, 1746 cm⁻¹) [125]. FTIR spectra measured for treated linolenic acid show a reduced signal at 3010 cm⁻¹ for all gases, and an increased signal at 2930 and 2830 cm⁻¹ for linolenic acid treated with argon and hydrogen. Other peaks observed are: 1239 cm⁻¹ as ester antisymmetric stretch, 1378 cm⁻¹ as methyl symmetric deformation, 1463 cm⁻¹ methyl antisymmetric deformation. As well as the epoxy group that corresponds to 862 cm⁻¹, which it is enhanced for nitrogen and argon treated samples.

FTIR spectra of nitrogen treated linolenic acid show peaks indicative of an amine (amine I band:1630 cm⁻¹; amine II band: 1552 cm⁻¹) [68]. This finding suggests that nitrogen has been incorporated into linolenic acid upon the treatment, and it is in agreement with a literature report wherein formation of fatty amines (—CH₂—CH(NH₂)—CH₂) was observed when treating soybean oil with nitrogen plasma to produce lubricants. Therefore, nitrogen gas treatment may result in addition of N into the fatty acid in spite of MS results that did not indicate the presence of nitrogen compounds. However, a fraction of the treated sample did not dissolve completely in hexane, acetonitrile, chloroform, or methanol, which prevented the MS analysis of this fraction. The nitrogen compounds may have remained in the insoluble fraction.

Treatment of linolenic acid with hydrogen gas resulted in its conversion to linoleic and oleic acid. This reaction may be initiated by production of hydrogen atoms from molecular hydrogen in the electric field. This is not entirely different from what occurs upon traditional catalytic hydrogenation, wherein molecular hydrogen is separated into atoms on the catalyst surface [5]. Compounds with C═C bonds then react with the hydrogen atoms on the surface, forming a saturated hydrocarbon.

However, it is interesting that similar changes in the structure of linolenic acid were detected when using either nitrogen or argon gas, suggesting that hydrogen atoms may come from another source than the gas in the plasma chamber. The hydrogen atoms may originate from the fatty acid or from water that dissociates in the plasma chamber.

The mass spectra for linolenic acid measured for the treated samples have a small peak corresponding to an ion of m/z 275.20, which was not detected in the untreated sample. This ion corresponds to a compound with four double bonds (C18:4), i.e., linolenic acid that has lost two hydrogen atoms to generate an extra double bond.

In order to explore the effects of water on the plasma hydrogenation reactions, trilinolenin was treated in the presence of dry and humid argon (for details of these experiments, see the experimental section). Untreated and treated trilinolenin samples were ionized in the mass spectrometer using (+) ESI doped with an ammonium salt [126]. The samples treated with humid argon contained greater amounts of the hydrogenated products, as indicated by the ions [M+2H+NH₄]⁺ and [M+4H+NH₄]⁺, with m/z 898.8 and m/z 900.8, respectively. This result suggests that the hydrogen atoms come from water, because its dissociation generates H and HO radicals as primary products. The presence of water in the plasma chamber increases the current, by a higher flow of electrons and collisions that increase rate of reactions such as dissociation and electron/ion recombination.

Mass spectra measured for linolenic acid treated with nitrogen and argon showed a higher relative abundance of ions [M+O+2H−H]⁻ and [M+O+4H−H]⁻, compared to the untreated linolenic acid. Suggesting that both hydrogenation and epoxidation reactions occurred upon HVACP. Indeed, trilinolenin treated with argon gas with low and high humidity showed the same reactions. The mass spectra measured for treated trilinolein samples showed [M+O+NH₄]⁺, [M+O+2H+NH₄]⁺ and [M+O+4H+NH₄]⁺ ions with m/z values of 912.8, 914.8 and 916.8, respectively. These ions have a higher abundance for samples treated under high moisture, again suggest-ing that water dissociation products hydrogenate and epoxidize unsaturated fatty acids.

The structural modifications of trilinolein upon HVACP treatment were further supported by FTIR spectroscopy. The reduction of double bonds (decrease in signal at 3010 cm⁻¹), and the increase in the number of single bonds (increase in signal at 2930 cm⁻¹ and 2830 cm⁻¹), were observed. Peaks corresponding to nitrogen compounds were not detected in the spectra of argon gas treated samples (no signals at 1630 cm⁻¹-1, or 1552 cm⁻¹). An increase in the signal intensity at 968 cm⁻¹-1 was observed for argon gas treated samples, and it corresponds to the trans-isomer that may be formed by an incomplete hydrogenation that leads to the restoration of a double bond into the isomer at the lower energy level [127]. This signal was not obvious the FTIR spectra measured for linolenic acid because of overlap with signals due to the carboxylic acid end of the fatty acid.

Source of Atomic Hydrogen.

Electrical excitation during cold plasma treatment produce energetic electrons that collide with neutral gases producing reactive species. The energy associated with these collisions have been described for common gases, as the cross sections for elastic and inelastic collisions, including excitation, dissociation, and ionization.

Atomic hydrogen formed from water dissociation may require less energy than the energy required to dissociate molecular hydrogen [43, 44]. Therefore, HVACP treatment may not reach the energy required to separate molecular hydrogen into atoms, and water becomes the source of hydrogen and oxygen that react with double bonds of unsaturated fatty acids.

HVACP treatment is proposed as a processing technology to modify the chemical structure of soybean oil. The application of this technology is focused in replacing catalytic hydrogenation, to produce partially hydrogenated soybean oil without trans-fatty acids, by adding hydrogen atoms produced in a high voltage electric field.

Liquid and solid samples of treated soybean oil were analyzed, reaching an IV of 122-123 and 90-100 IV, respectively. Samples treated with 100H increase the saturated fatty acid content from 20% to 36%, and reducing the PUFA from 58.6% to 38%, without detecting trans-fatty acids. An increased content of nitrogen was found in samples treated with nitrogen gas, but nitrated fatty acids were not detected with GC.

An increased content of hydrogen gas in the plasma chamber did not increase the hydrogenation rate. At the moment, it is not understood the relationship of nitrogen species with the reduction of unsaturated/increment of saturated FA, and this reaction will be analyzed further. ¹H-NMR results revealed that soybean oil maintain the triglyceride structure after HVACP treatments. However, the use of HVACP treatment involve complex interactions of reactive species with the oil structure that may include parallel reactions such as polymerization. Hexane and chloroform were used to dissolve untreated and treated soybean oil for GC and ¹H-NMR analysis, respectively. These solvents didn't dissolve completely the treated samples, and a further investigation is suggested to determine the structure of the insoluble fraction of the oil treated with plasma.

HVACP treatment of soybean oil by using nitrogen gas (but less so for hydrogen and argon gases) showed changes in the fatty acid composition, with a reduction in the amount of polyunsaturated fatty acids. Pure standards, linolenic acid and trilinolein, were treated similarly and the products analyzed with mass spectrometry. Hydrogenation and epoxidation of unsaturated double bonds were observed, where nitrogen gas treatment was recognized as the medium with higher amount of hydrogenated products. The generation of hydrogen atoms was identified mainly by water dissociation, hence increasing the relative humidity from 22% to 63% allowed to determine a significant increment in hydrogenated products with an argon modified atmosphere. In addition, a rearrangement of the molecules was also analyzed as a mechanism to obtain a hydrogenated product, however this reaction may involve transferring hydrogen atoms from one molecule (forming a double bond) to another (that lose the double bond). Epoxidation was another reaction identified in HVACP treatment, and this reaction may involve gas impurities, including oxygen and also water dissociation. Understanding the reaction mechanisms may help to increase yield and determine the parameters that need to be monitored to reduce epoxidation.

It is understood that multiple cycles of the cold plasma treatments may be required for certain types of products to meet enhanced requirements due to statutory or regulatory mandates, such as food products for the young, geriatric, or infirm population of people or animals.

It is understood that the process disclosed herein may be used independently or used in combination with other Hurdle technology, including thermal (low temperature long time, high temperature short time treatments, etc.) or non-thermal technologies (high pressure processing, microfiltration, carbonation, chlorination, ozonisation, ohmic heating, and the like) to treat liquid products.

Those skilled in the art will recognize that numerous modifications can be made to the specific implementations described above. The implementations should not be limited to the particular limitations described. Other implementations may be possible.

While the inventions have been illustrated and described in detail in the foregoing description, the same is to be considered as illustrative and not restrictive in character, it being understood that only certain embodiments have been shown and described and that all changes and modifications that come within the spirit of the invention are desired to be protected.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

### REFERENCES CITED

[1] F. D. Gunstone, Production and Trade of Vegetable Oils, 2011.
[2] R. O'Brien, Fats and oils. CRC Press, 2008.
[3] C. A. Martin, M. C. Milinsk, J. V. Visentainer, M. Matsushita, and N. E. De-Souza, “Trans fatty acid-forming processes in foods: A review,” Anais da Academia Brasileira de Ciencias, vol. 79, no. 2, pp. 343-350, 2007.
[4] J. W. E. Coenen, “Hydrogenation of Edible oils,” Journal of the American Oil Chemists Society, vol. 53, no. 6, pp. 382-389, 1976.
[5] A. J. Dijkstra, “Revisiting the formation of trans isomers during partial hydro-genation of triacylglycerol oils,” European Journal of Lipid Science and Tech-nology, vol. 108, no. 3, pp. 249-264, 2006.
[6] H. B. W. Patterson, Hydrogenation Methods, 2nd ed., G. R. List and J. W. King, Eds. AOCS press, 2010.
[7] G. R. List, W. E. Neff, R. L. Holliday, J. W. King, and R. Holser, “Hydrogena-tion of soybean oil triglycerides: Effect of pressure on selectivity,” Journal of the American Oil Chemists' Society, vol. 77, no. 3, pp. 311-314, 2000.
[8] G. R. List, W. C. Byrdwell, K. R. Steidley, R. O. Adlof, and W. E. Neff, “Triacylglycerol structure and composition of hydrogenated soybean oil mar-garine and shortening basestocks,” Journal of Agricultural and Food Chemistry, vol. 53, no. 12, pp. 4692-4695, 2005.
[9] R. H. Eckel, S. Borra, A. H. Lichtenstein, and S. Y. Yin-Piazza, “Understanding the complexity of trans fatty acid reduction in the American diet.” Circulation, vol. 115, no. 16, pp. 2231-2246, 2007.
[10] FDA, “Final Determination Regarding Partially Hydrogenated Oils,” The Daily Journal of the United States Goverment, vol. 80, no. 116, pp. 34 650-34 670, 2015.
[11] F. C. Wang, A. J. Gravelle, A. I. Blake, and A. G. Marangoni, “Novel trans fat replacement strategies,” Current Opinion in Food Science, vol. 7, pp. 27-34, 2016.
[12] T. P. Labuza and L. R. Dugan, “Kinetics of lipid oxidation in foods,” pp. 355-405, 1971.
[13] E. N. Frankel, Lipid Oxidation. Elsevier, 2014.
[14] E. Choe and D. B. Min, “Mechanisms and factors for edible oil oxidation,” pp. 169-186, 2006.
[15] E. N. Frankel, “Volatile lipid oxidation products,” Progress in Lipid Research, vol. 22, no. 1, pp. 1-33, 1983.
[16] A. G. Marangoni, “Organogels: An Alternative Edible Oil-Structuring Method,” Journal of the American Oil Chemists' Society, vol. 89, no. 5, pp. 749-780, 5 2012.
[17] A. R. Patel and K. Dewettinck, “Edible oil structuring: an overview and recent updates,” Food Function, vol. 7, no. 1, pp. 20-29, 2016.
[18] A. R. Patel, N. Cludts, M. D. B. Sintang, A. Lesaffer, and K. Dewettinck, “Edible oleogels based on water soluble food polymers: preparation, character-ization and potential application.” Food & function, vol. 5, no. 11, pp. 2833-41, 2014.
[19] M. Davidovich-Pinhas, S. Barbut, and A. G. Marangoni, “The role of surfactants on ethylcellulose oleogel structure and mechanical properties,” Carbohydrate Polymers, vol. 127, pp. 355-362, 2015.
[20] A. J. Gravelle, S. Barbut, and A. G. Marangoni, “Ethylcellulose oleogels: Manufacturing considerations and effects of oil oxidation,” Food Research Interna-tional, vol. 48, no. 2, pp. 578-583, 2012.
[21] M. Desroches, M. Escouvois, R. Auvergne, S. Caillol, and B. Boutevin, “From vegetable oils to polyurethanes: Synthetic routes to polyols and main industrial products,” Polymer Reviews, vol. 52, no. 1, pp. 38-79, 2012.
[22] K. M. Doll, S. C. Cermak, J. A. Kenar, and T. A. Isbell, “Synthesis and Charac-terization of Estolide Esters Containing Epoxy and Cyclic Carbonate Groups,” JAOCS, Journal of the American Oil Chemists' Society, vol. 93, no. 8, pp. 1149-1155, 2016.
[23] J. McNutt, Q. He, “Development of biolubricants from vegetable oils via chemical modification,” Journal of Industrial and Engineering Chemistry, vol. 36, pp. 1-12, 2015.
[24] T. A. Isbell and R. Kleiman, “Characterization of estolides produced from the acid-catalyzed condensation of oleic acid,” Journal of the American Oil Chemists' Society, vol. 71, no. 4, pp. 379-383, 1994.
[25] K. Kiefer, “Derivatization of Corn Oil for Analysis by GC,” Supelco Reporter, vol. 16, no. 3, p. 6, 1997.
[26] A. Barison, C. W. P. da Silva, F. R. Campos, F. Simonelli, C. A. Lenz, and A. G. Ferreira, “A simple methodology for the determination of fatty acid composition in edible oils through 1H NMR spectroscopy.” Magnetic resonance in chemistry: MRC, vol. 48, no. 8, pp. 642-50, 2010.
[27] G. Knothe and J. A. Kenar, “Determination of the fatty acid profile by 1H-NMR spectroscopy,” European Journal of Lipid Science and Technology, vol. 106, no. 2, pp. 88-96, 2004.
[28] A. Martinez-Yusta and M. D. Guill\acute{ }en, “Deep-frying food in extra virgin olive oil: A study by 1H nuclear magnetic resonance of the influence of food nature on the evolving composition of the frying medium,” Food Chemistry, vol. 150, pp. 429-437, 2014.
[29] F. Shahidi and U. N. Wanasundara, “Methods for Measuring Oxidative Ran-cidity in Fats and Oils,” Food Lipids: Chemistry, Nutrition, and Biotechnology, no. 1, pp. 387-407, 2002.
[30] P. Bruggeman and C. Leys, “Non-thermal plasmas in and in contact with liq-uids,” Journal of Physics D: Applied Physics, vol. 42, no. 5, 2009.
[31] A. Fridman, A. Chirokov, and A. Gutsol, “Non-thermal atmospheric pressure discharges,” Journal of Physics D: Applied Physics, vol. 38, no. 2, 2005.
[32] M. Capitelli, C. Ferreira, B. Gordiets, and A. Osipov, Plasma kinetics in atmo-spheric gases. Springer Berlin Heidelberg, 2000, vol. 162.
[33] N. Misra, X. Yepez, L. Xu, and K. Keener, “In-package cold plasma technolo-gies,” Journal of Food Engineering, vol. 244, pp. 21-31, 3 2019.
[34] N. N. Misra, B. K. Tiwari, K. S. M. S. Raghavarao, and P. J. Cullen, “Non-thermal Plasma Inactivation of Food-Borne Pathogens,” pp. 159-170, 2011.
[35] H. Lu, S. Patil, K. M. Keener, P. J. Cullen, and P. Bourke, “Bacterial inactiva-tion by high-voltage atmospheric cold plasma: Influence of process parameters and effects on cell leakage and DNA,” Journal of Applied Microbiology, vol. 116, no. 4, pp. 784-794, 2014.
[36] D. X. Liu, P. Bruggeman, F. Iza, M. Z. Rong, and M. G. Kong, “Global model of low-temperature atmospheric-pressure He+H₂O plasmas,” Plasma Sources Science and Technology, vol. 19, no. 2, 2010.
[37] J. Meichsner, M. Schmidt, R. Schneider, and H. Wagner, Nonthermal plasma chemistry and physics. CRC Press, 2013.
[38] D. X. Liu, M. Z. Rong, X. H. Wang, F. Iza, M. G. Kong, and P. Bruggeman, “Main species and physicochemical processes in cold atmospheric-pressure He+O2Plasmas,” Plasma Processes and Polymers, vol. 7, no. 9-10, pp. 846-865, 2010.
[39] S. Blanksby and G. Ellison, “Bond dissociation energies of organic molecules,” Acc. Chem. Res., vol. 36, no. 4, pp. 255-263, 2003.
[40] S. Jung, J. Lee, Y. Lim, W. Choe, H. I. Yong, and C. Jo, “Direct infusion of nitrite into meat batter by atmospheric pressure plasma treatment,” Innovative Food Science and Emerging Technologies, vol. 39, pp. 113-118, 2017.
[41] S. Patil, T. Moiseev, N. N. Misra, P. J. Cullen, J. P. Mosnier, K. M. Keener, and P. Bourke, “Influence of high voltage atmospheric cold plasma process parameters and role of relative humidity on inactivation of Bacillus atrophaeus spores inside a sealed package,” Journal of Hospital Infection, vol. 88, no. 3, pp. 162-169, 2014.
[42] F. Jud\acute{ }ee, S. Simon, C. Bailly, and T. Dufour, “Plasma-activation of tap wa-ter using DBD for agronomy applications: Identification and quantification of long lifetime chemical species” Water Research, vol. 133, pp. 47-59, 2018.
[43] Y. Itikawa, “Cross Sections for Electron Collisions with Nitrogen Molecules,” Journal of Physical and Chemical Reference Data, vol. 35, no. 1, pp. 31-53, 3 2006. [Online].
[44] J.-S. Yoon, M.-Y. Song, J.-M. Han, S. H. Hwang, W.-S. Chang, B. Lee, and Y. Itikawa, “Cross Sections for Electron Collisions with Hydrogen Molecules,” Journal of Physical and Chemical Reference Data, vol. 37, no. 2, pp. 913-931, 6 2008. [Online].
[45] Y. Itikawa and N. Mason, “Cross Sections for Electron Collisions with Water Molecules,” Journal of Physical and Chemical Reference Datafile:///Users/ximeyepez/Documents/OneDrive-purdue.edu/Literature/Plasma/Plasma diagnostics/Hydrogen spectra or reac-tions/Hydrogen species and hydrogenation/Itikawa 2006 Nitrogen cross section.pdf, vol. 34, no. 1, pp. 1-22, 3 2005.
[46] Z. Wang, “Sabatier-Senderens Reduction,” Comprehensive Organic Name Reactions and Reagents, pp. 2454-2457, 2010.
[47] D. Das and B. Sain, “Electrical transport phenomena prevailing in undoped nc-Si/a-SiNx:H thin films prepared by inductively coupled plasma chemical vapor deposition,” Journal of Applied Physics, vol. 114, no. 7, 2013.
[48] L. Camel, I. Gordon, K. Van Nieuwenhuysen, D. Van Gestel, G. Beaucarne, and J. Poortmans, “Defect passivation in chemical vapour deposited fine-grained polycrystalline silicon by plasma hydrogenation,” Thin Solid Films, vol. 487, no. 1-2, pp. 147-151, 2005.
[49] B. Swatowska and T. Stapinski, “Amorphous hydrogenated silicon-nitride films for applications in solar cells,” Vacuum, vol. 82, no. 10, pp. 942-946, 2008.
[50] N. Cherkasov, A. Ibhadon, P. F. C. E. and, and u. 2015, “A review of the existing and alternative methods for greener nitrogen fixation,” Elsevier.
[51] K. Sugiyama, K. Akazawa, M. Oshima, H. Miura, T. Matsuda, and O. Nomura, “Ammonia synthesis by means of plasma over MgO catalyst,” Plasma Chemistry and Plasma Processing, vol. 6, no. 2, pp. 179-193, 6 1986.
[52] J. Winter, K. Wende, K. Masur, S. Iseni, M. Du\ddot{ }nnbier, M. U. Hammer, H. Tresp, K. D. Weltmann, and S. Reuter, “Feed gas humidity: A vital pa-rameter affecting a cold atmospheric-pressure plasma jet and plasma-treated human skin cells,” Journal of Physics D: Applied Physics, vol. 46, no. 29, 2013.
[53] A. Lacombe, B. A. Niemira, J. B. Gurtler, X. Fan, J. Sites, G. Boyd, and H. Chen, “Atmospheric cold plasma inactivation of aerobic microorganisms on blueberries and effects on quality attributes,” Food Microbiology, vol. 46, pp. 479-484, 2015.
[54] B. G. Dasan, I. H. Boyaci, and M. Mutlu, “Nonthermal plasma treatment of Aspergillus spp. spores on hazelnuts in an atmospheric pressure fluidized bed plasma system: Impact of process parameters and surveillance of the residual viability of spores,” Journal of Food Engineering, vol. 196, pp. 139-149, 2017.
[55] L. B\acute{ }ardos and H. Bar\acute{ }ankov\acute{ }a, “Cold atmospheric plasma: Sources, processes, and applications,” pp. 6705-6713, 2010.
[56] M. Y. Won, S. J. Lee, and S. C. Min, “Mandarin preservation by microwave-powered cold plasma treatment,” Innovative Food Science and Emerging Technologies, vol. 39, pp. 25-32, 2017.
[57] C. Hertwig, K. Reineke, J. Ehlbeck, B. Erdodu, C. Rauh, and O. Schlu\ddot{ }ter, “Impact of remote plasma treatment on natural microbial load and quality parameters of selected herbs and spices,” Journal of Food Engineering, vol. 167, pp. 12-17, 2015.
[58] J. A. Slezak, B. D. Zion, and S. J. Sibener, “Enhanced oxidation rate of Ni(111) by atomic oxygen,” Surface Science, vol. 442, no. 1, 1999.
[59] I. Albertos, A. B. Martin-Diana, P. J. Cullen, B. K. Tiwari, S. K. Ojha, P. Bourke, C. Alvarez, and D. Rico, “Effects of dielectric barrier discharge (DBD) generated plasma on microbial reduction and quality parameters of fresh mackerel fillets,” Innovative Food Science and Emerging Technologies, vol. 44, no. August 2016, pp. 117-122, 2017.
[60] I. Albertos, A. Martin-Diana, P. Cullen, B. Tiwari, S. Ojha, P. Bourke, and D. Rico, “Shelf-life extension of herring using in-package atmospheric plasma technology,” Innovative Food Science & Emerging Technologies, no. September, 2017.
[61] C. Sarangapani, D. Ryan Keogh, J. Dunne, P. Bourke, and P. J. Cullen, “Characterisation of cold plasma treated beef and dairy lipids using spectro-scopic and chromatographic methods,” Food Chemistry, vol. 235, pp. 324-333, 2017.
[62] J. D. McClurkin-Moore, K. E. Ileleji, K. M. Keener, et al., “Cold plasma: a potential new method to manage postharvest diseases caused by fungal plant pathogens. S. S. Siddique,” Food and Bioprocess Technology, vol. 10, no. 30, pp. 1431-1440, 2017.
[63] M. Korachi, F. Ozen, N. Aslan, L. Vannini, M. E. Guerzoni, D. Got-tardi, and F. Y. Ekinci, “Biochemical changes to milk following treatment by a novel, cold atmospheric plasma system,” Interna-tional Dairy Journal, vol. 42, pp. 64-69, 2014.
[64] J. Vandamme, A. Nikiforov, K. Dujardin, C. Leys, L. De Cooman, and J. Van Durme, “Critical evaluation of non-thermal plasma as an innovative accelerated lipid oxidation technique in fish oil,” Food Research International, vol. 72, pp. 115-125, 2015.
[65] J. Van Durme and J. Vandamme, “Non-thermal plasma as preparative tech-nique to evaluate olive oil adulteration,” Food Chemistry, vol. 208, pp. 185-191, 2016.
[66] J. Van Durme, A. Nikiforov, J. Vandamme, C. Leys, and A. De Winne, “Accelerated lipid oxidation using non-thermal plasma technology: Evaluation of volatile compounds,” Food Research International, vol. 62, pp. 868-876, 2014. [Online].
[67] J. Vandamme, A. Nikiforov, M. De Roose, C. Leys, L. De Cooman, and J. Van Durme, “Controlled accelerated oxidation of oleic acid using a DBD plasma: Determination of volatile oxidation compounds,” Food Research International, vol. 79, pp. 54-63, 2016.
[68] X. Zhao, J. Yang, D. Tao, and X. Xu, “Synthesis and Tribological Properties of Air Plasma Polymerized Soybean Oil with N-Containing Structures,” Journal of the American Oil Chemists' Society, vol. 91, no. 5, pp. 827-837, 5 2014.
“Tribological study of nitrogen plasma polymerized soybean oil with nitrogen heterocyclic structures,” Industrial Crops and Products, vol. 51, pp. 236-243, 2013.
[70] D. Patient, “The Chemistry of Pastry Products,” Nutrition and Food Science, vol. 94, no. 4, pp. 33-35, 1994.
[71] P. Sabatier, Catalysis in organic chemistry. D. Van Nostrand, 1922.
[72] I. Horiuti and M. Polanyi, “Exchange reactions of hydrogen on metallic catalysts,” Trans Faraday Soc., vol. 30, p. 1164, 1934.
[73] R. D. O. Brien, Oils and fats: Formulating and Processing for Applications, 2004.
[74] A. E. W. Beers, “Low trans hydrogenation of edible oils,” Technology, vol. 19, no. 3, pp. 56-58, 2007.
[75] I. Karabulut, M. Kayahan, and S. Yaprak, “Determination of changes in some physical and chemical properties of soybean oil during hydrogenation,” Food Chemistry, vol. 81, no. 3, pp. 453-456, 2003.
[76] ASA, “Soybean Oil: U.S. Vegetable oils consumption,” 2018.
[77] M. T. Tarrago-Trani, K. M. Phillips, L. E. Lemar, and J. M. Holden, “New and Existing Oils and Fats Used in Products with Reduced Trans-Fatty Acid Content,” Journal of the American Dietetic Association, vol. 106, no. 6, pp. 867-880, 2006.
[78] E. Anderson, “Process for electrical treatment of liquids,” 1926.
[79] A. Hemptinne, “Manufacture of lubricating oils,” p. 3, 1910.
[80] W. J. Sweeney, “Voltolization of hydrogenated products,” pp. 6-8, 1941.
[81] K. M. Keener, J. Jensen, V. Valdramidis, E. Byrne, J. Connolly, J. P. Mosnier, and P. J. Cullen, Plasma for Bio-Decontamination, Medicine and Food Security, ser. NATO Science for Peace and Security Series A: Chemistry and Biology, Z. Machala, K. Hensel, and Y. Akishev, Eds. Springer Netherlands, 2012.
[82] R. R. Allen, “Principles and catalysts for hydrogenation of fats and oils,” Jour-nal of the American Oil Chemists' Society, vol. 55, no. 11, pp. 792-795, 1978.
[83] A. Grill, Cold plasma in materials fabrication: from fundamental to applica-tions. IEEE Press, 1994.
[84] D. C. Elias, R. R. Nair, T. M. G. Mohiuddin, S. V. Morozov, P. Blake, M. P. Halsall, A. C. Ferrari, D. W. Boukhvalov, M. I. Katsnelson, A. K. Geim, and K. S. Novoselov, “Control of graphene's properties by reversible hydrogenation: evidence for graphane.” Science (New York, N.Y.), vol. 323, no. 5914, pp. 610-3, 2009.
[85] M. Keidar and I. I. Beilis, Plasma Engineering, 2013.
[86] I. W. Wu, T. Y. Huang, W. B. Jackson, A. G. Lewis, and A. Chiang, “Passi-vation Kinetics of Two Types of Defects in Polysilicon TFT by Plasma Hydro-genation,” IEEE Electron Device Letters, vol. 12, no. 4, pp. 181-183, 1991.
[87] A. Kramida, Y. Ralchenko, J. Reader, and NIST Atomic Spectra Database Team, “NIST Atomic Spectra Database (version 5.3),” 2015.
[88] F. Rigas and S. Sklavounos, “Evaluation of hazards associated with hydrogen storage facilities,” International Journal of Hydrogen Energy, vol. 30, no. 13-14, pp. 1501-1510, 2005.
[89] D. Firestone, “Official Methods and Recommended Practices of the AOCS,” in Iodine value of fats and oils cyclohexane method, 6th ed., 2009, vol. Cd 1b-87 r.
[90] H. Tawara, Y. Itikawa, H. Nishimura, and M. Yoshino, “Cross Sections and Related Data for Electron Collisions with Hydrogen Molecules and Molecular Ions,” Journal of Physical and Chemical Reference Data, vol. 19, no. 3, pp. 617-636, 1990.
[91] A. Bogaerts and R. Gijbels, “Effects of adding hydrogen to an argon glow discharge: overview of relevant processes and some qualitative explanations,” Journal of Analytical Atomic Spectrometry, vol. 15, no. 4, pp. 441-449, 2000.
[92] J. Connolly, V. P. Valdramidis, E. Byrne, K. a. Karatzas, P. J. Cullen, K. M. Keener, and J. P. Mosnier, “Characterization and antimicrobial efficacy against E. coli of a helium/air plasma at atmospheric pressure created in a plastic package,” Journal of Physics D: Applied Physics, vol. 46, p. 35401, 2013.
[93] P. Andre, J. Aubreton, M. F. Elchinger, P. Fauchais, and A. Lefort, “A new modified pseudoequilibrium calculation to determine the composition of hydrogen and nitrogen plasmas” Plasma Chemistry and Plasma Processing, vol. 21, no. 1, pp. 83-105, 2001.
[94] A. Beers, R. Ariaansz, and D. Okonek, “Trans Isomer Control in Hydrogenation of Edible Oils,” Trans Fatty Acids, vol. 1911, pp. 147-180, 2008.
[95] J. W. Veldsink, M. J. Bouma, N. H. Sch\ddot{ }oon, and A. a. C. M. Beenackers, “Het-erogeneous Hydrogenation of Vegetable Oils: A Literature Review,” Catalysis Reviews, vol. 39, no. 3, pp. 253-318, 1997.
[96] ERS, “USDA Economic Research Service,” 2016.
[97] L. Xu, A. L. Garner, B. Tao, and K. M. Keener, “Microbial Inactivation and Quality Changes in Orange Juice Treated by High Voltage Atmospheric Cold Plasma,” Food and Bioprocess Technology, vol. 10, no. 10, pp. 1778-1791, 2017.
[98] D. Ziuzina, S. Patil, P. Cullen, K. Keener, and P. Bourke, “Atmospheric cold plasma inactivation of [symbol] i_{¿}, Escherichia coli [symbol] /i_{¿}, in liquid media inside a sealed package,” Journal of Applied Microbiology, vol. 114, no. 3, pp. 778-787, 3 2013.
[99] S. Pankaj, C. Bueno-Ferrer, N. Misra, L. ONeill, B. Tiwari, P. Bourke, and P. Cullen, “Characterization of dielectric barrier discharge atmospheric air cold plasma treated gelatin films,” Food Packaging and Shelf Life, vol. 6, pp. 61-67, 2015.
[100] L. Scally, J. Lalor, P. J. Cullen, and V. Milosavljevi\acute{ }c, “Impact of atmospheric pressure nonequilibrium plasma discharge on polymer surface metrology,” Jour-nal of Vacuum Science & Technology A: Vacuum, Surfaces, and Films, vol. 35, no. 3, p. 03E105, 2017.
[101] AOAC, Official Methods of Analysis of AOAC International, 2005.
[102] X. V. Yepez and K. M. Keener, “High-voltage Atmospheric Cold Plasma (HVACP) hydrogenation of soybean oil without trans-fatty acids,” Innovative Food Science & Emerging Technologies, vol. 38, pp. 169-174, 2016.
[103] S. Pankaj, C. Bueno-Ferrer, N. Misra, V. Milosavljevi\acute{ }c, C. O'Donnell, P. Bourke, K. Keener, and P. Cullen, “Applications of cold plasma technology in food packaging,” Trends in Food Science & Technology, vol. 35, no. 1, pp. 5-17, 2014.
[104] J. Keeler, Understanding NMR spectroscopy, 2nd ed. Wiley, 2010.
[105] A. Mart\acute{ }mez-Yusta, E. Goicoechea, and M. D. Guill\acute{ }en, “A Review of Thermo-Oxidative Degradation of Food Lipids Studied by 1H NMR Spectroscopy: In-fluence of Degradative Conditions and Food Lipid Nature,” Comprehensive Re-views in Food Science and Food Safety, vol. 13, no. 5, pp. 838-859, 2014.
[106] A. Biswas, A. Adhvaryu, D. G. Stevenson, B. K. Sharma, J. L. Willet, and S. Z. Erhan, “Microwave irradiation effects on the structure, viscosity, thermal properties and lubricity of soybean oil,” Industrial Crops and Products, vol. 25, no. 1, pp. 1-7, 2007.
[107] E. Hatzakis, A. Agiomyrgianaki, S. Kostidis, and P. Dais, “High-resolution NMR spectroscopy: An alternative fast tool for qualitative and quantitative analysis of diacylglycerol (DAG) oil,” JAOCS, Journal of the American Oil Chemists' Society, vol. 88, no. 11, pp. 1695-1708, 2011.
[108] C. O. Laux, T. G. Spence, C. H. Kruger, and R. N. Zare, “Optical diagnostics of atmospheric pressure air plasmas,” Plasma Sources Sci. Technol., vol. 12, pp. 125-138, 2003.
[109] C. Parigger, J. W. L. Lewis, and D. Plemmons, “Electron number density and temperature measurement in a laser-induced hydrogen plasma,” Journal of Quantitative Spectroscopy and Radiative Transfer, vol. 53, no. 3, pp. 249-255, 1995.
[110] K. J. Clay, S. P. Speakman, G. Amaratunga, and S. R. P. Silva, “Character-ization of a-C:H:N deposition from CH4/N2 rf plasmas using optical emission spectroscopy,” Journal of Applied Physics, vol. 79, no. 9, p. 7227, 1996.
[111] N. N. Misra, A. Martynenko, F. Chemat, L. Paniwnyk, F. J. Barba, and A. R. Jambrak, “Thermodynamics, transport phenomena, and electrochemistry of external field-assisted nonthermal food technologies,” pp. 1-32, 2017.
[112] J. Van Durme, J. Dewulf, C. Leys, and H. Van Langenhove, “Combining non-thermal plasma with heterogeneous catalysis in waste gas treatment: A review,” Applied Catalysis B: Environmental, vol. 78, no. 3-4, pp. 324-333, 2008.
[113] J. Hong, M. Aramesh, O. Shimoni, D. H. Seo, S. Yick, A. Greig, C. Charles, S. Prawer, and A. B. Murphy, “Plasma Catalytic Synthesis of Ammonia Using Functionalized-Carbon Coatings in an Atmospheric-Pressure Non-equilibrium Discharge,” Plasma Chemistry and Plasma Processing, vol. 36, no. 4, pp. 917-940, 2016.
[114] Y. Kubota, K. Koga, M. Ohno, and T. Hara, “Synthesis of Ammonia through Direct Chemical Reactions between an Atmospheric Nitrogen Plasma Jet and a Liquid,” Plasma and Fusion Research, vol. 5, pp. 042-042, 2010.
[115] J. J. Max and C. Chapados, “Aqueous ammonia and ammonium chloride hydrates: Principal infrared spectra,” Journal of Molec-ular Structure, vol. 1046, pp. 124-135, 2013. [Online]. Available: http://dx.doi.org/10.1016/j.molstruc.2013.04.045
[116] T. Mizushima, K. Matsumoto, J. I. Sugoh, H. Ohkita, and N. Kakuta, “Tubular membrane-like catalyst for reactor with dielectric-barrier-discharge plasma and its performance in ammonia synthesis,” Applied Catalysis A: General, vol. 265, no. 1, pp. 53-59, 2004.
[117] L. Bromberg, “Plasma catalytic reforming of methane,” International Journal of Hydrogen Energy, vol. 24, no. 12, pp. 1131-1137, 1999.
[118] E. C. Neyts, K. Ostrikov, M. K. Sunkara, and A. Bogaerts, “Plasma Catalysis: Synergistic Effects at the Nanoscale,” Chemical Reviews, vol. 115, no. 24, pp. 13 408-13 446, 2015.
[119] P. Attri, B. Arora, and E. H. Choi, “Retracted Article: Utility of plasma: a new road from physics to chemistry,” RSC Adv., vol. 3, no. 31, pp. 12 540-12 567, 2013. [Online].
[120] P. A. Klockow and K. M. Keener, “Safety and quality assessment of packaged spinach treated with a novel ozone-generation system,” LWT—Food Science and Technology, vol. 42, no. 6, pp. 1047-1053, 2009.
[121] N. N. Misra and C. Jo, “Applications of cold plasma technology for microbiolog-ical safety in meat industry,” Trends in Food Science and Technology, vol. 64, pp. 74-86, 2017.
[122] X. Yepez and K. Keener, “High-voltage Atmospheric Cold Plasma (HVACP) hydrogenation of soybean oil without trans-fatty acids,” Innovative Food Sci-ence and Emerging Technologies, vol. 38, 2016.
[123] D. Jovanovic, “Nickel hydrogenation catalyst for tallow hydrogenation and for the selective hydrogenation of sunflower seed oil and soybean oil,” Catalysis Today, vol. 43, no. 1-2, pp. 21-28, 1998.
[124] D.-x. Liu, F. Iza, X.-h. Wang, D. Liu, B. Sun, F. Iza, D. Xu, and X. Wang, “atmospheric pressure plasma jets propagating into humid air Main species and chemical pathways in cold atmospheric-pressure Ar+H 2 O plasmas,” 2017.
[125] M. D. Guill\acute{ }en and N. Cabo, “Characterization of edible oils and lard by fourier transform infrared spectroscopy. Relationships between composition and fre-quency of concrete bands in the fingerprint region,” Journal of the American Oil Chemists' Society, vol. 74, no. 10, pp. 1281-1286, 1997.
[126] A. M. McAnoy, C. C. Wu, and R. C. Murphy, “Direct qualitative analysis of triacylglycerols by electrospray mass spectrometry using a linear ion trap,” Journal of the American Society for Mass Spectrometry, vol. 16, no. 9, pp. 1498-1509, 2005.
[127] D. Lin-Vien, N. B. Colthup, W. B. Fateley, and J. G. Graselli, “Characteristic Raman Vibrational Frequencies of Organic Groups,” in The Handbook of In-frared and Raman Characteristic Frequencies of Organic Molecules, 1991, no. 1103, pp. 1-2.
[128] R. Thirumdas, A. Trimukhe, R. R. Deshmukh, and U. S. Annapure, “Functional and rheological properties of cold plasma treated rice starch,” Carbohydrate Polymers, vol. 157, pp. 1723-1731, 2017.
[129] S. K. Pankaj, Z. Wan, J. E. De Le\acute{ }on, C. Mosher, W. Colonna, and K. M. Keener, “High-voltage atmospheric cold plasma treatment of different types of starch films,” Starch—St\ddot{ }arke, vol. 1700009, p. 1700009, 2017.
[130] K. Ostrikov, E. C. Neyts, and M. Meyyappan, “Plasma nanoscience: From nano-solids in plasmas to nano-plasmas in solids,” Advances in Physics, vol. 62, no. 2, pp. 113-224, 2013.
[131] H. Wang, T. Maiyalagan, and X. Wang, “Review on recent progress in nitrogen-doped graphene: Synthesis, characterization, and its potential applications,” ACS Catalysis, vol. 2, no. 5, pp. 781-794, 2012.
[132] Y. Shao, S. Zhang, M. H. Engelhard, G. Li, G. Shao, Y. Wang, J. Liu, I. A. Aksay, and Y. Lin, “Nitrogen-doped graphene and its electrochemical applications,” Journal of Materials Chemistry, vol. 20, no. 35, p. 7491, 2010.
[133] J. S. Burgess, B. R. Matis, J. T. Robinson, F. A. Bulat, F. Keith Perkins, B. H. Houston, and J. W. Baldwin, “Tuning the electronic properties of graphene by hydrogenation in a plasma enhanced chemical vapor deposition reactor,” Carbon, vol. 49, no. 13, pp. 4420-4426, 2011.
[134] S. C. Chew and K. L. Nyam, “Oxidative Stability of Microencapsulated Kenaf Seed Oil Using Co-extrusion Technology,” JAOCS, Journal of the American Oil Chemists' Society, vol. 93, no. 4, pp. 607-615, 2016.
[135] R. Crompton, “Carbon hydrogen polymers,” Thermal stability of polymers, pp. 1-44, 2012.
[136] B. Muik, B. Lendl, A. Molina-D\acute{ }iaz, and M. J. Ayora-Can\tilde{ }ada, “Direct monitor-ing of lipid oxidation in edible oils by Fourier transform Raman spectroscopy,” Chemistry and Physics of Lipids, vol. 134, no. 2, pp. 173-182, 2005.
[137] F. R. Voort, A. A. Ismail, J. Sedman, and G. Emo, “Monitoring the oxidation of edible oils by Fourier transform infrared spectroscopy,” J. Am. Oil Chem. Soc., vol. 71, no. 3, pp. 243-253, 1994.
[138] N. Vlachos, Y. Skopelitis, M. Psaroudaki, V. Konstantinidou, A. Chatzilazarou, and E. Tegou, “Applications of Fourier transform-infrared spectroscopy to edi-ble oils,” Analytica Chimica Acta, vol. 573-574, pp. 459-465, 2006.
[139] X. Liao, D. Liu, Q. Xiang, J. Ahn, S. Chen, X. Ye, and T. Ding, “Inactivation mechanisms of non-thermal plasma on microbes” Food Control, vol. 75, pp. 83-91, 2017.
[140] A. I. Muhammad, Q. Xiang, X. Liao, D. Liu, and T. Ding, “Understanding the Impact of Nonthermal Plasma on Food Constituents and MicrostructureA Review,” Food and Bioprocess Technology, vol. 11, no. 3, pp. 463-486, 2018.
[141] R. B. Pegg, “Measurement Of Primary Lipid Oxidation Products,” Handbook of Food Analytical Chemistry, vol. 1-2, pp. 515-529, 2005.
[142] S. C. Cermak and T. A. Isbell, “Synthesis of estolides from oleic acid and saturated fatty acids,” vol. 78, no. 6, pp. 557-565, 2001.
[143] C. Sarangapani, G. O'Toole, P. J. Cullen, and P. Bourke, “Atmospheric cold plasma dissipation efficiency of agrochemicals on blueberries,” Innovative Food Science and Emerging Technologies, vol. 44, pp. 235-241, 2017.
[144] A. Adhvaryu and S. Z. Erhan, “Epoxidized soybean oil as a potential source of high-temperature lubricants,” Industrial Crops and Products, vol. 15, no. 3, pp. 247-254, 2002.

What is claimed is:

1. A process for manufacturing a hydrogenated vegetable oil without any significant amount of trans fatty acids using a high voltage atmospheric cold plasma (HVACP), comprising the steps of:
a. preparing vegetable oil;
b. setting up a defined compartment filled with a working gas in the presence of water and an electric system for generating atmospheric cold plasma (ACP);
c. generating ACP by applying a high electric voltage through a controller; and
d. exposing said vegetable oil to said ACP in said defined compartment to afford said hydrogenated vegetable oil without any significant amount of trans fatty acids.

2. The process of claim 1, wherein said ACP is generated by applying an electric voltage from about 5,000 volts to about 200,000 volts between two dielectric barriers for a period of time.

3. The process of claim 1, wherein said ACP is generated by applying an electric voltage from about 30,000 volts to about 120,000 volts between two dielectric barriers for a period of time.

4. The process of claim 1, wherein said hydrogenated vegetable oil has an iodine value of 100 or lower.

5. The process of claim 1, wherein said working gas is a single or a mixture of combined gases.

6. The process of claim 1, wherein said working gas is air, hydrogen, nitrogen, oxygen, carbon dioxide, noble gases, water, or a combination thereof.

7. The process of claim 6, wherein said working gas is air.

8. The process of claim 6, wherein said working gas is a modified air comprising about 65% oxygen, about 30% carbon dioxide, and about 5% nitrogen.

9. The process of claim 1, wherein said vegetable oil is soybean oil.

10. The process of claim 1, wherein said vegetable oil is corn oil.

11. The process of claim 1, wherein said vegetable oil is canola oil.

12. The process of claim 1, wherein said vegetable oil is peanut oil.

13. The process of claim 1, wherein said hydrogenated vegetable oil contains little or no significant amount of trans fatty acids.

14. The process of claim 1, wherein said hydrogenated vegetable oil meets the criteria of the United States Food and Drug Administration for GRAS (generally regarded as safe).

15. A product of hydrogenated vegetable oil manufactured by using high voltage atmospheric cold plasma (HVACP), according a process comprising the steps of:
a. preparing vegetable oil;
b. setting up a defined compartment filled with a working gas in the presence of water and an electric system for generating atmospheric cold plasma (ACP);
c. generating ACP by applying a high electric voltage through a controller; and
d. exposing said vegetable oil to said ACP in said defined compartment to afford said hydrogenated vegetable oil without any significant amount of trans fatty acids.

16. The product of claim 15, wherein said working gas is air, hydrogen, nitrogen, oxygen, carbon dioxide, noble gases, water, or a combination thereof.

17. The product of claim 15, wherein said ACP is generated by applying an electric voltage from about 30,000 volts to about 120,000 volts between two dielectric barriers for a period of time.

18. The product of claim 15, wherein said vegetable oil is soybean oil.

19. The product of claim 15, wherein said hydrogenated vegetable oil contains little or no significant amount of trans fatty acids.

20. The product of claim 15, wherein said hydrogenated vegetable oil meets the criteria of the United States Food and Drug Administration for GRAS (generally regarded as safe).
